(19) United States
(12) Patent Application Publication
(10) Pub. No.: US 2024/0022973 A1
(43) Pub. Date: Jan. 18, 2024

(54) METHODS FOR MOBILITY RELATED HANDOVER FOR MR-DC

(71) Applicant: Telefonaktiebolaget LM Ericsson (publ), Stockholm (SE)

(72) Inventors: Pradeepa RAMACHANDRA, Linköping (SE); Icaro Leonardo DA SILVA, Solna (SE); Helka-Liina MÄÄTTÄNEN, Espoo (FI)

(21) Appl. No.: 18/034,990

(22) PCT Filed: Nov. 3, 2021
(86) PCT No.: PCT/IB2021/060185

§ 371 Date: May 2, 2023

Related U.S. Application Data
(60) Provisional application No. 63/109,267, filed on Nov. 3, 2020.

(51) Int. Cl. H04W 36/00

(52) U.S. Cl. CPC H04W 36/0069; H04W 36/0058; H04W 36/0072

(57) ABSTRACT

A method in operating user equipment, UE, according to some embodiments includes receiving a first mobility configuration for lower layer mobility associated to multiple physical cell identities, PCIs, for a cell, of a Secondary Cell Group, SCG, for operating in multi-radio access technology dual connectivity, MR-DC. The lower layer mobility is used to trigger a change of PCI upon reception of a lower layer signaling by the UE. The method further includes operating according to the mobility configuration for the cell of the SCG while operating in MR-DC. Related network node methods are disclosed.

### RELATED APPLICATION

The present application claims the benefit of and priority to U.S. Provisional Patent Application No. 63/109,267 filed Nov. 3, 2020, entitled “METHODS FOR L1/L2 CENTRIC MOBILITY FOR MR-DC,” the disclosure of which is hereby incorporated herein by reference in its entirety.

### BACKGROUND

The present disclosure relates generally to communications, and more particularly to communication methods and related devices and nodes supporting wireless communications.

In connected state, a User Equipment (UE) has a connection established to the network. The aim of connected-state mobility is to ensure that the connectivity is retained with no interruption or noticeable degradation as the device moves within the network. The UE is required to do searches for new cells both on the current carrier frequency (intra-frequency) and different carrier frequencies (inter-frequency) that are informed by the network. The UE does not make any decisions on its own regarding when it is time to trigger a handover (HO) procedure to a different cell. This is rather based on a variety of triggering conditions. In general, the UE reports the results of any configured measurements to the network so that the network can make a decision on whether or not it is time for handover to a new cell.

In 5G New Radio (NR), handover is a special case of a procedure called “reconfiguration with sync.” In addition, a variety of handover mechanisms, such as Dual Active Protocol Stack (DAPS), conditional handover (CHO), and RACH-less HO, have been introduced in specifications to enhance the mobility robustness performance for challenging scenarios that require low-latency and high reliability performance.

The LTE protocol stack generally includes three layers, L1, L2 and L3. L1 includes the physical layer (PHY). L2 encompasses the medium access control (MAC), radio link control (RLC) and packet data convergence protocol (PDCP) layers, and L3 encompasses the radio resource control (RRC) and non-access stratum (NAS) layers. The functions of these layers are defined in the NR standard specification documents. Generally, lower layers in the protocol stack provide services to higher layers. Higher level operations are typically handled at higher layers. For example, handover is typically managed at the L3 level by RRC.

The basic L3 HO is quite similar to the LTE mobility functionality: it is based on event-driven measurement reporting over RRC, where the UE performs measurement on various reference signals (mapping to cells) and filters these measurements. When the filtered measurements fulfil certain criteria parametrized by the NW, the UE will trigger a measurement report. However, differently from LTE, a cell may be defined by multiple beams, which may be realized by multiple SS/PBCH Blocks (SSB)s transmitted in different directional beams, while in LTE a single broadcasted signal is transmitted, as shown in FIG. 1, which illustrates differences between cell definition in NR and LTE.

That leads to a procedure where changing beams from different cells require RRC signaling and a set of UE protocols actions, e.g., reset of buffers, etc.

FIG. 2 illustrates inter-cell inter-node beam changing (handover realized with RRC signaling in Rel-15).

The configuration of a target primary Secondary Cell Group (SCG) cell (PSCell) (which in prior art is a single cell with a single PCI associated to it) in a HO command message (i.e. the RRCReconfiguration) includes the following:
servCellIndex of IE ServCellIndex: The PCell of the Master Cell Group uses ID=0. The IE ServCellIndex concerns a short identity, used to identify a serving cell (i.e. the PCell, the PSCell or an SCell). Value 0 applies for the PCell, while the SCellIndex that has previously been assigned applies for SCells.
rlf-TimersAndConstants of IE SetupRelease {RLF-TimersAndConstants}: Timers and constants for detecting and triggering cell-level radio link failure.
rlmInSyncOutOfSyncThreshold: BLER threshold pair index for IS/OOS indication generation, see TS [4], table 8.1.1-1. n1 corresponds to the value 1. When the field is absent, the UE applies the value 0. Whenever this is reconfigured, the UE resets N310 and N311, and stops T310, if running. Network does not include this field.
spCellConfigDedicated of IE ServingCellConfig: used to configure (add or modify) the UE with a serving cell, e.g. PCel of an MCG. The parameters herein are mostly UE specific but partly also cell specific (e.g. in additionally configured bandwidth parts). Reconfiguration between a PUCCH and PUCCHless SCell is only supported using an SCell release and add. This is where in legacy the TCI states are configured, and the QCL associated with SSBs/CSI-RS.
ReconfigurationWithSync:
   spCellConfigCommon (of IE ServingCellConfigCommon): used to configure cell specific parameters of a UE's serving cell. The IE contains parameters which a UE would typically acquire from SSB, MIB or SIBs when accessing the cell from IDLE. With this IE, the network provides this information in dedicated signalling when configuring a PCell upon reconfiguration with sync.
   newUE-Identity of IE RNTI-Value: C-RNTI for this cell group
   t304: supervision timer started upon reconfiguration with sync and upon expiry the UE declares a handover/reconfiguration with sync failure.
   rach-ConfigDedicated: Random access configuration to be used for the reconfiguration with sync (e.g. handover). The UE performs the RA according to these parameters in the firstActiveUplinkBWP (see UplinkConfig).
   Smtc: The SSB periodicity/offset/duration configuration of target cell for NR PSCell change, NR PCell change and NR PSCell addition. The network sets the periodicityAndOffset to indicate the same periodicity as ssb-periodicityServingCell in spCellConfigCommon. For case of NR PCell change and NR PSell addition, the smtc is based on the timing reference of (source) PCell. For case of NR PSCell change, it is based on the timing reference of source PSCell. If the field is absent, the UE uses the SMTC in the measObjectNR having the same SSB frequency and subcarrier spacing, as configured before the reception of the RRC message.

L1/L2 Centric Mobility in Rel-17

L1/L2 centric inter-cell mobility (or L1-mobility, inter-PCI TCI state change/update/modification, etc.) has been introduced. This is justified in the Work Item Description (WID) RP-193133 (Further enhancements on MIMO for NR) by the fact that while Rel-16 manages to offer some reduction in overhead and/or latency, high-speed vehicular scenarios (e.g., a UE traveling at high speed on highways) at FR2 require more aggressive reduction in latency and overhead—not only for intra-cell, but also for L1/L2 centric inter-cell mobility. That translates in the following objective:

Enhancement on multi-beam operation, mainly targeting FR2 while also applicable to FR1:
Identify and specify features to facilitate more efficient (lower latency and overhead) DL/UL beam management to support higher intra- and L1/L2-centric inter-cell mobility and/or a larger number of configured TCI states:
   a. Common beam for data and control transmission/reception for DL and UL, especially for intra-band CA
   b. Unified TCI framework for DL and UL beam indication
   c. Enhancement on signaling mechanisms for the above features to improve latency and efficiency with more usage of dynamic control signaling (as opposed to RRC)
Identify and specify features to facilitate UL beam selection for UEs equipped with multiple panels, considering UL coverage loss mitigation due to MPE, based on UL beam indication with the unified TCI framework for UL fast panel selection.

L1/L2 inter-cell centric mobility should be understood as a UE receiving a L1/L2 signaling (instead of RRC signaling) indicating a TCI state (e.g. for PDCCH) associated to an SSB whose PCI is not necessarily the same as the PCI of the cell the UE has connected to e.g. via connection resume or connection establishment. In other words, L1/L2-centric inter-cell mobility procedure can be interpreted as a beam management operation expanding the coverage of multiple SSBs associated to multiple PCIs (e.g. possibly associated to the same cell or different cells).

RAN2 has discussed over email how to enable mPDCCH mTRP support in higher layers. It was proposed to add a list of additional SSBs (including PCI) in ServingCellConfig; and add a reference to one entry of that list in QCL-Info (only included when the reference is SSB).

Further, in P79165 multiple sets of SSBs are considered, where each set has its independent PCI configured for the UE, in serving cell configuration. A fundamental aspect here is that under a serving cell, a unique SSB can be indicated by the pair {SSB index and PCI}compared to Rel.-15 where only SSB index was used to address a unique SSB.

Multi-Radio Dual-Connectivity

Multi-Radio Dual Connectivity (MR-DC) is a generalization of the Intra-E-UTRA Dual Connectivity (DC) as described in [6], where a multiple Rx/Tx capable UE may be configured to use resources provided by two different nodes connected via non-ideal backhaul, one providing NR access and the other one providing either E-UTRA or NR access. One node acts as the Master Node (MN) and the other as the Secondary Node (SN). The MN and SN are connected via a network interface and at least the MN is connected to the core network.

When configured with MR-DC, the UE typically operates initially a serving cell group called a master cell group (MCG). The UE is then configured by the network with an additional cell group called a SCG. Each cell group (CG) can have one or more serving cells. MCG and SCG can be operated from geographically non-collocated gNBs. MCG and SCG can be operated with corresponding serving cells belonging to different frequency ranges and/or corresponding serving cells in same and different frequency ranges. In an example, a MCG can have serving cells in FR1, and SCG can also have serving cells in FR1.

There are different ways to deploy 5G network with or without interworking with LTE (also referred to as E-UTRA) and evolved packet core (EPC), as depicted in FIG. 3. In principle, NR and LTE can be deployed without any interworking, denoted by NR stand-alone (SA) operation, that is gNB in NR can be connected to 5G core network (5GC) and eNB can be connected to EPC with no interconnection between the two (Option 1 and Option 2 in the figure). On the other hand, the first supported version of NR is the so-called EN-DC (E-UTRAN-NR Dual Connectivity), illustrated by Option 3. In such a deployment, dual connectivity between NR and LTE is applied with LTE as the master and NR as the secondary node. The RAN node (gNB) supporting NR, may not have a control plane connection to core network (EPC), instead it relies on the LTE as master node (MeNB). This is also called as “Non-standalone NR”. Notice that in this case the functionality of an NR cell is limited and would be used for connected mode UEs as a booster and/or diversity leg, but an RRC_IDLE UE cannot camp on these NR cells.

As migration for these options may differ from different operators, it is possible to have deployments with multiple options in parallel in the same network e.g. there could be eNB base station supporting option 3, 5 and 7 in the same network as NR base station supporting 2 and 4. In combination with DC solutions between LTE and NR it is also possible to support CA (Carrier Aggregation) in each cell group (i.e. MCG and SCG) and dual connectivity between nodes on same RAT (e.g. NR-NR DC). For the LTE cells, a consequence of these different deployments is the co-existence of LTE cells associated to eNBs connected to EPC, 5GC or both EPC/5GC.

In [5], the procedures for MR-DC are classified as MR-DC with the EPC (also called EN-DC) and MR-DC with 5GC.

MR-DC with the EPC (EN-DC)

E-UTRAN supports MR-DC via EN-DC, in which a UE is connected to one eNB that acts as a MN and one en-gNB that acts as a SN. The eNB is connected to the EPC via the S1 interface and to the en-gNB via the X2 interface. The en-gNB might also be connected to the EPC via the S1-U interface and other en-gNBs via the X2-U interface. The EN-DC architecture is illustrated in FIG. 4.

MR-DC with the 5GC

E-UTRA-NR Dual Connectivity: NG-RAN supports NG-RAN E-UTRA-NR Dual Connectivity (NGEN-DC), in which a UE is connected to one ng-eNB that acts as a MN and one gNB that acts as a SN.

NR-E-UTRA Dual Connectivity: NG-RAN supports NR-E-UTRA Dual Connectivity (NE-DC), in which a UE is connected to one gNB that acts as a MN and one ng-eNB that acts as a SN.

NR-NR Dual Connectivity: NG-RAN supports NR-NR Dual Connectivity (NR-DC), in which a UE is connected to one gNB that acts as a MN and another gNB that acts as a SN. In addition, NR-DC can also be used when a UE is connected to two gNB-DUs, one serving the MCG and the other serving the SCG, connected to the same gNB-CU, acting both as a MN and as a SN.

MR-DC Control Plane Architecture

A UE in MR-DC has a single control plane connection to the core network and a single RRC state, controlled by the MN. Both MN and SN has an own RRC entity for creating RRC messages or Information Elements (IE) for configuring the UE. Since the SN is responsible for its own resources, it provides the UE with the SCG configuration in an RRC message and also the radio bearer configuration in an IE, for all bearers that are terminated in the SN. The MN in turn creates the MCG configuration and the radio bearer configuration for all bearers terminated in the MN. The cell group configuration includes the configuration of L1 (physical layer), MAC and RLC. The radio bearer configuration includes the configuration of PDCP (and SDAP in case of 5GC).

The MN always sends the initial SN RRC configuration via MCG SRB (SRB1), but subsequent RRC configurations created by the SN can be sent to the UE either via the MN using SRB1 or directly to the UE using SRB3 (if configured). For the SRB1 case, the MN receives from the SN an RRC message containing the SCG configuration and an IE containing the radio bearer configuration. The MN encapsulates these into the RRC message it creates itself, that may also include changes to the MCG configuration and radio bearer configuration of bearers terminated in the MN. Thereby, the MCG and SCG configurations may be sent to the UE in the same RRC message.

Split SRB1 is used to create diversity. From RRC point of view, it operates like normal SRB1. However, on PDCP level, the sender can decide to either choose one of the links for scheduling the RRC messages, or it can duplicate the message over both links. In the downlink, the path switching between the MCG or SCG legs or duplication on both is left to network implementation. For the UL, the network configures the UE to use the MCG, SCG or both legs. The terms “leg”, “path” and “RLC bearer” are used interchangeably throughout this document.

For the SRB3 case, the SN creates the RRC message including the SCG configuration and radio bearer configuration for radio bearers terminated in the SN. SN may only use SRB3 for reconfigurations not requiring coordination with MN.

FIG. 5 illustrates a control plane architecture for EN-DC (left) and MR-DC with 5GC (right).

SN Addition/PSCell Addition (Configuring a UE with MR-DC)

The Secondary Node (SN) Addition procedure (shown in FIG. 7) is initiated by the Master Node (MN) and is used to establish a UE context at the SN to provide resources from the SN to the UE. For bearers requiring SCG radio resources, this procedure is used to add at least the initial SCG serving cell of the SCG. This procedure can also be used to configure an SN terminated MCG bearer (where no SCG configuration is needed). The example below illustrates the procedure for MR-DC with 5G Core Network (5GC) but same principles applied for EN-DC.

FIG. 6 illustrates the following operations in the SN addition procedure.
1. The MN decides to request the target SN to allocate resources for one or more specific PDU Sessions/QoS Flows. In addition, for bearers requiring SCG radio resources, MN indicates the requested SCG configuration information, including the entire UE capabilities and the UE capability coordination result. In this case, the MN also provides the latest measurement results for SN to choose and configure the SCG cell(s). The MN may request the SN to allocate radio resources for split SRB operation. In NGEN-DC and NR-DC, the MN always provides all the needed security information to the SN (even if no SN terminated bearers are setup) to enable SRB3 to be setup based on SN decision.
2. If the RRM entity in the SN is able to admit the resource request, it allocates respective radio resources and, dependent on the bearer type options, respective transport network resources. For bearers requiring SCG radio resources the SN triggers UE Random Access (RA) so that synchronisation of the SN radio resource configuration can be performed. The SN decides for the PSCell and other SCG SCells and provides the new SCG radio resource configuration to the MN within an SN RRC configuration message contained in the SN Addition Request Acknowledge message.
2a. For SN terminated bearers using MCG resources, the MN provides Xn-U DL TNL address information in the Xn-U Address Indication message.
3. The MN sends the MN RRC reconfiguration message to the UE including the SN RRC configuration message, without modifying it.
4. The UE applies the new configuration and replies to MN with MN RRC reconfiguration complete message, including an SN RRC response message for SN, if needed. In case the UE is unable to comply with (part of) the configuration included in the MN RRC reconfiguration message, it performs the reconfiguration failure procedure.
5. The MN informs the SN that the UE has completed the reconfiguration procedure successfully via SN Reconfiguration Complete message, including the SN RRC response message, if received from the UE.
6. If configured with bearers requiring SCG radio resources, the UE performs synchronisation towards the PSCell configured by the SN. The order the UE sends the MN RRC reconfiguration complete message and performs the RA procedure towards the SCG is not defined. The successful RA procedure towards the SCG is not required for a successful completion of the RRC Connection Reconfiguration procedure.
7. If PDCP termination point is changed to the SN for bearers using RLC AM, and when RRC full configuration is not used, the MN sends the SN Status Transfer.
8. For SN terminated bearers or QoS flows moved from the MN, dependent on the characteristics of the respective bearer or QoS flow, the MN may take actions to minimise service interruption due to activation of MR-DC (Data forwarding).
9-12. If applicable, the update of the UP path towards the 5GC is performed via a PDU Session Path Update procedure.

SN Modification/PSCell Change (Intra-SN PSCell Mobility for a UE with MR-DC)

The SN Modification procedure may be initiated either by the MN or by the SN and be used to modify the current user plane resource configuration (e.g. related to PDU session, QoS flow or DRB) or to modify other properties of the UE context within the same SN. It may also be used to transfer an RRC message from the SN to the UE via the MN and the response from the UE via MN to the SN (e.g. when SRB3 is not used). In NGEN-DC and NR-DC, the RRC message is an NR message (i.e., RRCReconfiguration) whereas in NE-DC it is an E-UTRA message (i.e., RRCConnectionReconfiguration). In case of CPC, this procedure is used to configure or modify CPC configuration within the same SN. The CPC configuration cannot be used to configure target PSCell in NE-DC. The SN modification procedure does not necessarily need to involve signaling towards the UE.

FIG. 7 illustrates the operations of an SN initiated SN Modification with MN involvement.

The SN uses the procedure to perform configuration changes of the SCG within the same SN, e.g. to trigger the modification/release of the user plane resource configuration and to trigger PSCell changes (e.g. when a new security key is required or when the MN needs to perform PDCP data recovery).
1. The SN sends the SN Modification Required message including an SN RRC reconfiguration message, which may contain a new radio resource configuration of SCG.
2/3. The MN initiated SN Modification procedure may be triggered by SN Modification Required message, e.g. when an SN security key change needs to be applied.
4. The MN sends the MN RRC reconfiguration message to the UE including the SN RRC reconfiguration message with the new SCG radio resource configuration.
5. The UE applies the new configuration and sends the MN RRC reconfiguration complete message, including an SN RRC response message, if needed. In case the UE is unable to comply with (part of) the configuration included in the MN RRC reconfiguration message, it performs the reconfiguration failure procedure.
6. Upon successful completion of the reconfiguration, the success of the procedure is indicated in the SN Modification Confirm message including the SN RRC response message, if received from the UE.
7. If instructed, the UE performs synchronisation towards the PSCell configured by the SN as described in SN Addition procedure. Otherwise, the UE may perform UL transmission directly after having applied the new configuration.

FIG. 9 illustrates an SN initiated SN Modification without MN involvement.

This procedure is not supported for NE-DC.

The SN initiated SN modification procedure without MN involvement is used to modify the configuration within SN in case no coordination with MN is required, including the addition/modification/release of SCG SCell and PSCell change (e.g. when the security key does not need to be changed and the MN does not need to be involved in PDCP recovery). The SN may initiate the procedure to configure or modify CPC configuration within the same SN. FIG. 8 shows an example signalling flow for an SN initiated SN modification procedure without MN involvement. The SN can decide whether the Random Access procedure is required.
1. The SN sends the SN RRC reconfiguration message to the UE through SRB3.
2. The UE applies the new configuration and replies with the SN RRC reconfiguration complete message. In case the UE is unable to comply with (part of) the configuration included in the SN RRC reconfiguration message, it performs the reconfiguration failure procedure.
3. If instructed, the UE performs synchronisation towards the PSCell of the SN as described in SN Addition procedure. Otherwise the UE may perform UL transmission after having applied the new configuration.
3a. In case of CPC, the UE maintains connection with source PSCell after receiving CPC configuration, and starts evaluating the CPC execution conditions for the candidate PSCell(s). If at least one CPC candidate PSCell satisfies the corresponding CPC execution condition, the UE detaches from the source PSCell, applies the stored corresponding configuration for that selected candidate PSCell and synchronises to that candidate PSCell. The UE completes the CPC execution procedure by sending an RRCReconfigurationComplete message to the new PSCell.

FIG. 9 illustrates Transfer of an NR RRC message to/from the UE (when SRB3 is not used).

This procedure is supported for all the MR-DC options.

The SN initiates the procedure when it needs to transfer an NR RRC message to the UE and SRB3 is not used.
1. The SN initiates the procedure by sending the SN Modification Required to the MN including the SN RRC reconfiguration message.
2. The MN forwards the SN RRC reconfiguration message to the UE including it in the RRC reconfiguration message.
3. The UE applies the new configuration and replies with the RRC reconfiguration complete message by including the SN RRC reconfiguration complete message.
3a. If CPC is configured in the RRCReconfiguration, the UE maintains connection with source PSCell after receiving CPC configuration, and starts evaluating the CPC execution conditions for the candidate PSCell(s). If at least one CPC candidate PSCell satisfies the corresponding CPC execution condition, the UE detaches from the source PSCell, applies the stored corresponding configuration for the selected candidate PSCell and synchronises to that candidate PSCell. The UE completes the CPC execution procedure by an ULInformationTransferMRDC message to the MN which includes an embedded RRCReconfigurationComplete message to the new PSCell. The RRCReconfigurationComplete is forwarded to the SN embedded in RRC Transfer.
4. The MN forwards the SN RRC response message, if received from the UE, to the SN by including it in the SN Modification Confirm message.
5. If instructed, the UE performs synchronisation towards the PSCell of the SN as described in SN Addition procedure. Otherwise, the UE may perform UL transmission after having applied the new configuration.

In this case of intra-SN PSCell change, there can be two sub-cases: Intra-SN and intra-DU; and Intra-SN and inter-DU.

SN/PSCell Change (Inter-SN PSCell Mobility for a UE with MR-DC)

The MN initiated SN change procedure is used to transfer a UE context from the source SN (S-SN) to a target SN (T-SN) and to change the SCG configuration in the UE from one SN to another.

The SN Change procedure always involves signalling over MCG SRB towards the UE.

FIG. 10 illustrates an SN change procedure—MN initiated. In particular, FIG. 10 shows an example signalling flow for the SN Change initiated by the MN:
1/2. The MN initiates the SN change by requesting the T-SN to allocate resources for the UE by means of the SN Addition procedure. The MN may include measurement results related to the target SN. If data forwarding is needed, the T-SN provides data forwarding addresses to the MN. The T-SN includes the indication of the full or delta RRC configuration. The MN may trigger the MN-initiated SN Modification procedure (to the S-SN) to retrieve the current SCG configuration and to allow provision of data forwarding related information before step 1.
3. If the allocation of target SN resources was successful, the MN initiates the release of the source SN resources including a Cause indicating SCG mobility. The Source SN may reject the release. If data forwarding is needed the MN provides data forwarding addresses to the source SN. If direct data forwarding is used for SN terminated bearers, the MN provides data forwarding addresses as received from the target SN to source SN. Reception of the SN Release Request message triggers the source SN to stop providing user data to the UE.
4/5. The MN triggers the UE to apply the new configuration. The MN indicates the new configuration to the UE in the MN RRC reconfiguration message including the target SN RRC reconfiguration message. The UE applies the new configuration and sends the MN RRC reconfiguration complete message, including the SN RRC response message for the target SN, if needed. In case the UE is unable to comply with (part of) the configuration included in the MN RRC reconfiguration message, it performs the reconfiguration failure procedure.
6. If the RRC connection reconfiguration procedure was successful, the MN informs the target SN via SN Reconfiguration Complete message with the included SN RRC response message for the target SN, if received from the UE.
7. If configured with bearers requiring SCG radio resources the UE synchronizes to the T-SN.
8. If PDCP termination point is changed for bearers using RLC AM, the source SN sends the SN Status Transfer, which the MN sends then to the target SN, if needed.
9. If applicable, data forwarding from the source SN takes place. It may be initiated as early as the source SN receives the SN Release Request message from the MN.
10. The S-SN sends the Secondary RAT Data Usage Report message to the MN and includes the data volumes delivered to and received from the UE as described in clause 10.11.2.

The order the SN sends the Secondary RAT Data Usage Report message and performs data forwarding with MN is not defined. The SN may send the report when the transmission of the related QoS flow is stopped.
11-15. If applicable, a PDU Session path update procedure is triggered by the MN.
16. Upon reception of the UE Context Release message, the S-SN releases radio and C-plane related resources associated to the UE context. Any ongoing data forwarding may continue.

FIG. 11 illustrates an SN initiated SN Change procedure.

The SN initiated SN change procedure is used to transfer a UE context from the source SN to a target SN and to change the SCG configuration in UE from one SN to another.

FIG. 11 shows an example signalling flow for the SN Change initiated by the SN. The signalling flow includes the following operations:
1. The source SN initiates the SN change procedure by sending the SN Change Required message, which contains a candidate target node ID and may include the SCG configuration (to support delta configuration) and measurement results related to the target SN.
2/3. The MN requests the target SN to allocate resources for the UE by means of the SN Addition procedure, including the measurement results related to the target SN received from the source SN. If data forwarding is needed, the target SN provides data forwarding addresses to the MN. The target SN includes the indication of the full or delta RRC configuration.
4/5. The MN triggers the UE to apply the new configuration. The MN indicates the new configuration to the UE in the MN RRC reconfiguration message including the SN RRC reconfiguration message generated by the T-SN. The UE applies the new configuration and sends the MN RRC reconfiguration complete message, including the SN RRC response message for the target SN, if needed. In case the UE is unable to comply with (part of) the configuration included in the MN RRC reconfiguration message, it performs the reconfiguration failure procedure.
6. If the allocation of T-SN resources was successful, the MN confirms the change of the S-SN. If data forwarding is needed the MN provides data forwarding addresses to the S-SN. If direct data forwarding is used for SN terminated bearers, the MN provides data forwarding addresses as received from the T-SN to S-SN. Reception of the SN Change Confirm message triggers the S-SN to stop providing user data to the UE and, if applicable, to start data forwarding.
7. If the RRC connection reconfiguration procedure was successful, the MN informs the target SN via SN Reconfiguration Complete message with the included SN RRC response message for the target SN, if received from the UE.
8. The UE synchronizes to the target SN.
9. If PDCP termination point is changed for bearers using RLC AM, the source SN sends the SN Status Transfer, which the MN sends then to the target SN, if needed.
10. If applicable, data forwarding from the source SN takes place. It may be initiated as early as the source SN receives the SN Change Confirm message from the MN.
11. The S-SN sends the Secondary RAT Data Usage Report message to the MN and includes the data volumes delivered to and received from the UE as described in clause 10.11.2. The order the SN sends the Secondary RAT Data Usage Report message and performs data forwarding with MN/T-SN is not defined. The SN may send the report when the transmission of the related QoS flow is stopped.
12-16. If applicable, a PDU Session path update procedure is triggered by the MN.
17. Upon reception of the UE Context Release message, the S-SN releases radio and C-plane related resources associated to the UE context. Any ongoing data forwarding may continue.

### SUMMARY

A method in operating user equipment, UE, according to some examples includes receiving a first mobility configuration for lower layer mobility associated to multiple physical cell identities, PCIs, for a cell, of a Secondary Cell Group, SCG, for operating in multi-radio access technology dual connectivity, MR-DC. The lower layer mobility is used to trigger a change of PCI upon reception of a lower layer signaling by the UE. The method further includes operating according to the mobility configuration for the cell of the SCG while operating in MR-DC.

Some embodiments provide a user equipment, UE, including processing circuitry, and memory coupled with the processing circuitry, wherein the memory may include instructions that when executed by the processing circuitry causes the UE to perform operations according to any of the foregoing embodiments.

A user equipment, UE, according to some embodiments is adapted to perform according to any of the foregoing embodiments.

Some embodiments provide a computer program product including a non-transitory storage medium including program code to be executed by processing circuitry of a UE, whereby execution of the program code causes the UE to perform operations according to any of the foregoing embodiments.

A method of operating a first network node according to some embodiments includes receiving, from a second network node, measurement results for a user equipment, UE, served by the second network node. The measurement results are associated to multiple cells or PCIs associated to the first network node. The method further includes generating a mobility configuration for lower layer mobility of the UE associated to the multiple PCIs. The lower layer mobility is used to trigger a change of PCI of a cell in a secondary cell group, SCG, of the UE upon reception of a lower layer signaling by the UE. The method further includes transmitting the mobility configuration to the first node for transmission to the UE.

A method of operating a second network node according to some embodiments includes transmitting a first message to a first network node. The first message includes measurement results associated to multiple cells or multiple PCIs associated to the first network node. The measurement results were reported to the second network node by a UE served by the second network node. The method further includes receiving a second message from the first network node, the message including a secondary cell group, SCG, reconfiguration, and transmitting the SCG reconfiguration to the UE.

Some embodiments provide a network node including processing circuitry, and memory coupled with the processing circuitry, wherein the memory includes instructions that when executed by the processing circuitry causes the network node to perform operations according to any of the foregoing embodiments.

A network node (or RAN node) according to some embodiments includes processing circuitry, and memory coupled with the processing circuitry, wherein the memory may include instructions that when executed by the processing circuitry causes the RAN node to perform operations according to any of the foregoing embodiments.

Some embodiments provide a computer program product including a non-transitory storage medium including program code to be executed by processing circuitry of a radio access network, RAN, node, whereby execution of the program code causes the RAN node to perform operations according to any of the foregoing embodiments.

Embodiments described herein may provide certain advantages. For example, mobility robustness can be increased thanks to low layer (L1/L2 centric) mobility for SCG/PSCell changes. Other potential advantages include signaling reductions and latency reduction when configuring lower layer mobility for MR-DC.

Indeed, mobility robustness for the PSCell mobility can be increased thanks to the fact that the UE is configured with L1/L2-centric mobility for performing PCI change for a PSCell and/or PSCell change which speeds up the PSCell change (as there is no need to involve the MN and/or the CU at the SN).

In addition to it, further robustness can be achieved for the case the PSCell configuration during SN Addition and/or SN Change and/or SN Modification includes random access configuration(s) with beams (mapped to random access resources) associated to more than one PCI and/or more than one PSCell, the UE has a higher degree of diversity to select a beam (i.e. a direction) to perform random access and select a target PSCell/TRP/PCI.

Another potential advantage is the signaling reduction to configure L1/L2 centric mobility for the PSCell thanks to the fact that already during a PSCell Addition and/or PSCell Change (not after the PSCell Addition or after the PSCell Change, in a subsequent reconfiguration) i.e., upon reception of the RRCReconfiguration with a reconfiguration with sync (e.g. for the SCG), the UE is aware of the multiple PCI(s) of the PSCell for L1/L2 centric mobility and/or the multiple PSCell(s) for L1/L2 centric mobility for the SCG. In other words, the UE does not require to first access a target PSCell (via random access and transmitting an RRCReconfigurationComplete) to then receive from the target SN an RRCReconfiguration including the L1/L2 centric mobility for the SCG. In the case multiple PSCell(s) are configured for L1/L2 centric mobility, these PCIs may correspond to non-serving cell(s).

### BRIEF DESCRIPTION OF THE DRAWINGS

FIG. 1 illustrates PSS/SSS configurations in LTE and NR.

FIG. 2 illustrates inter-cell inter-node beam changing in NR.

FIG. 3 illustrates various MR-DC scenarios.

FIG. 4 illustrates the EN-DC architecture.

FIG. 5 illustrates a control plane architecture for EN-DC and MR-DC with 5GC.

FIG. 6 illustrates a Secondary Node (SN) addition procedure.

FIG. 7 illustrates operations of an SN initiated SN Modification with MN involvement.

FIG. 8 illustrates an example signalling flow for an SN initiated SN modification procedure without MN involvement.

FIG. 9 illustrates Transfer of an NR RRC message to/from the UE.

FIG. 10 illustrates an SN change procedure.

FIG. 11 illustrates an SN initiated SN change procedure.

FIG. 12 illustrates an MR-DC deployment scenario.

FIG. 13 illustrates a Primary Synchronization Sequence (PSS) and a Secondary Synchronization Sequence (SSS).

FIG. 14 is a flowchart that illustrates a method at a UE according to some embodiments.

FIG. 15 illustrates operations of a UE, Master Node and Secondary Node according to some embodiments.

FIGS. 16 and 17 illustrate deployment scenarios according to some embodiments.

FIGS. 18 and 19 illustrate operations of various system elements according to some embodiments.

FIG. 20 is a block diagram illustrating a wireless device (UE) according to some embodiments.

FIG. 21 is a block diagram illustrating a radio access network RAN node (e.g., a base station eNB/gNB) according to some embodiments.

FIG. 22 is a flow chart illustrating operations of a UE according to some embodiments.

FIGS. 23 and 24 are a flow charts illustrating operations of radio access network nodes according to some embodiments.

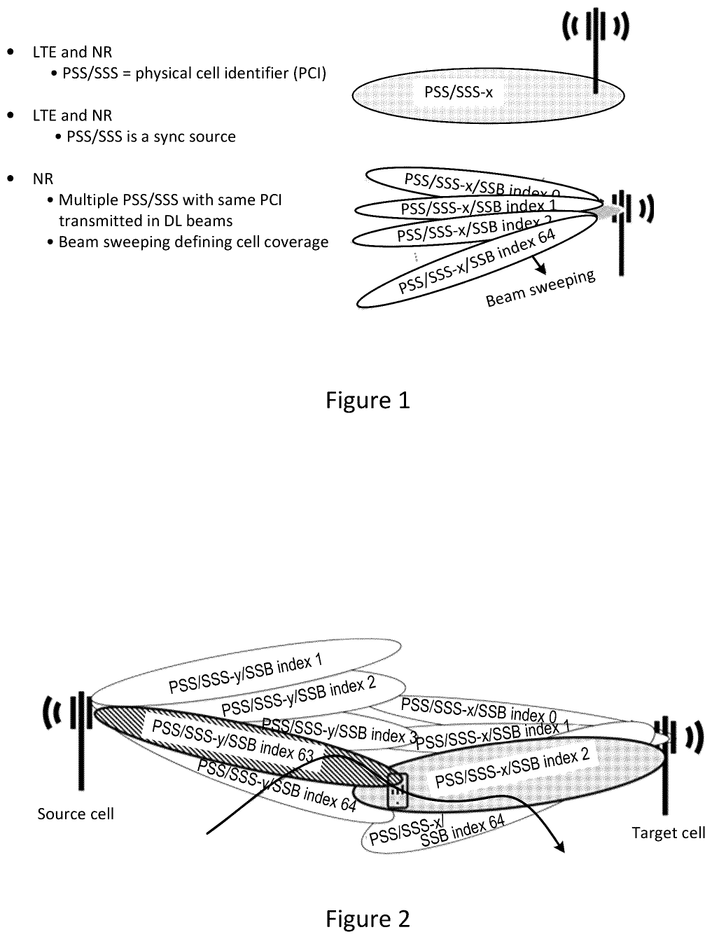

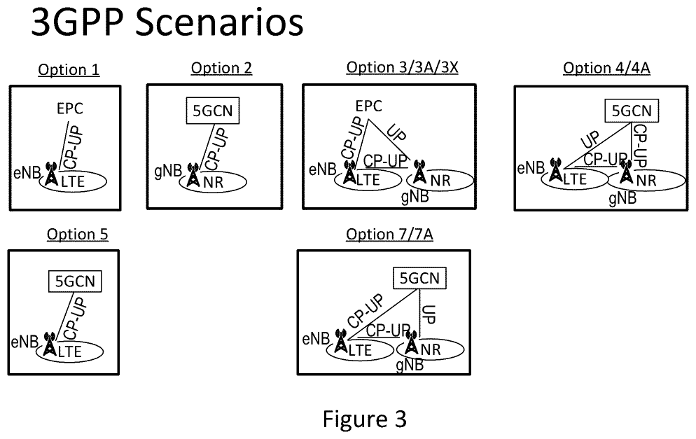

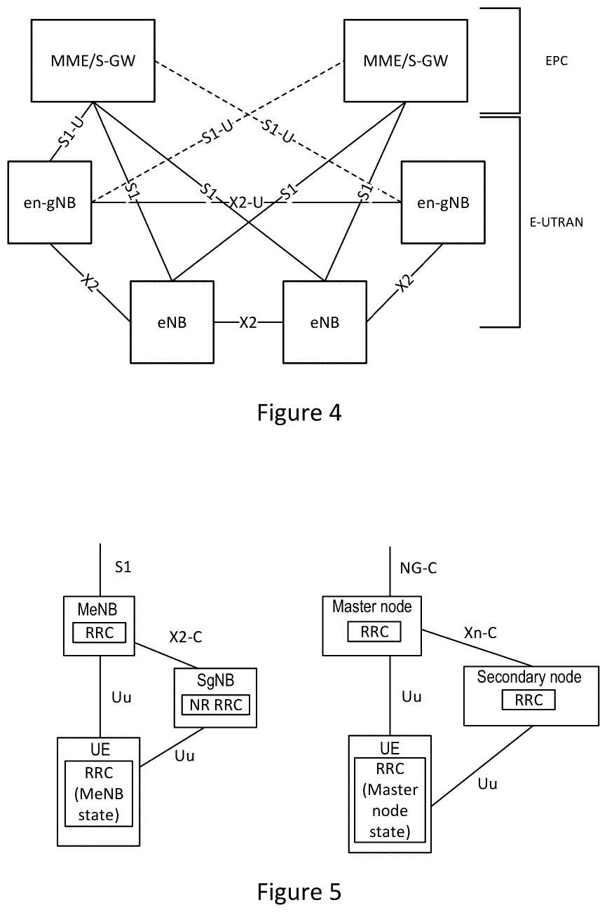

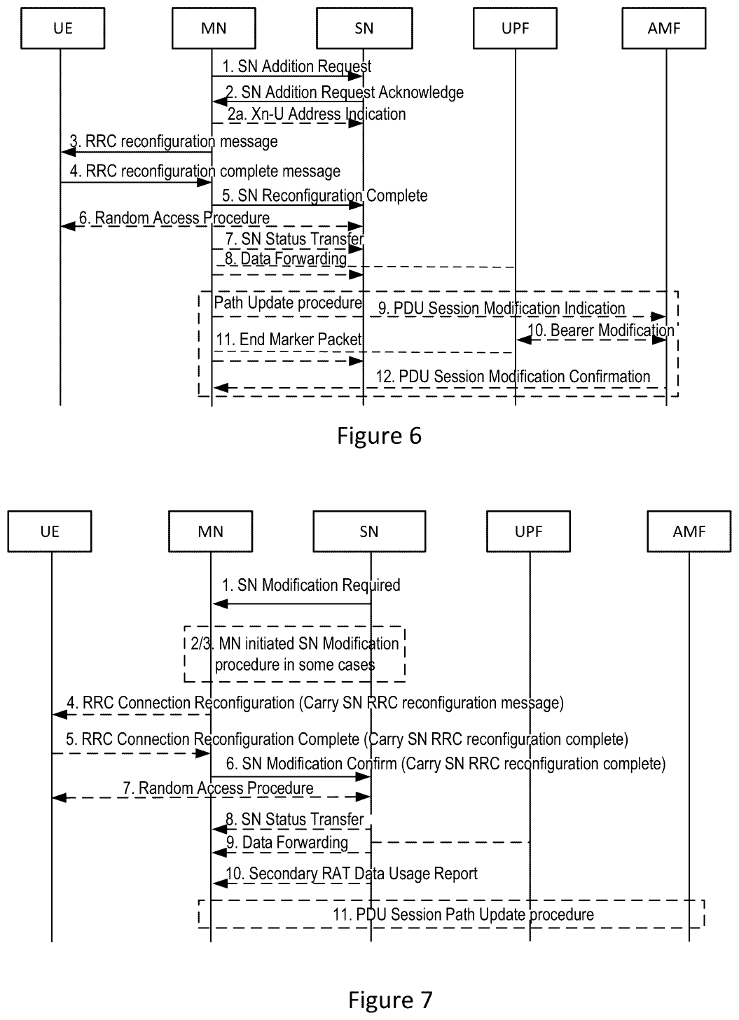

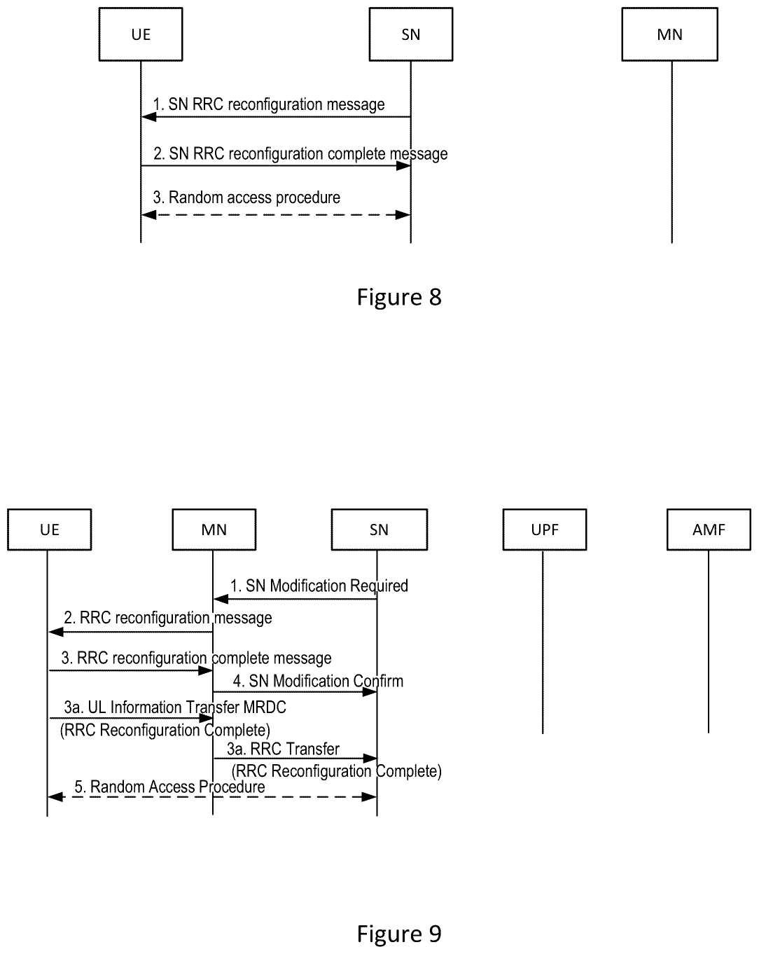

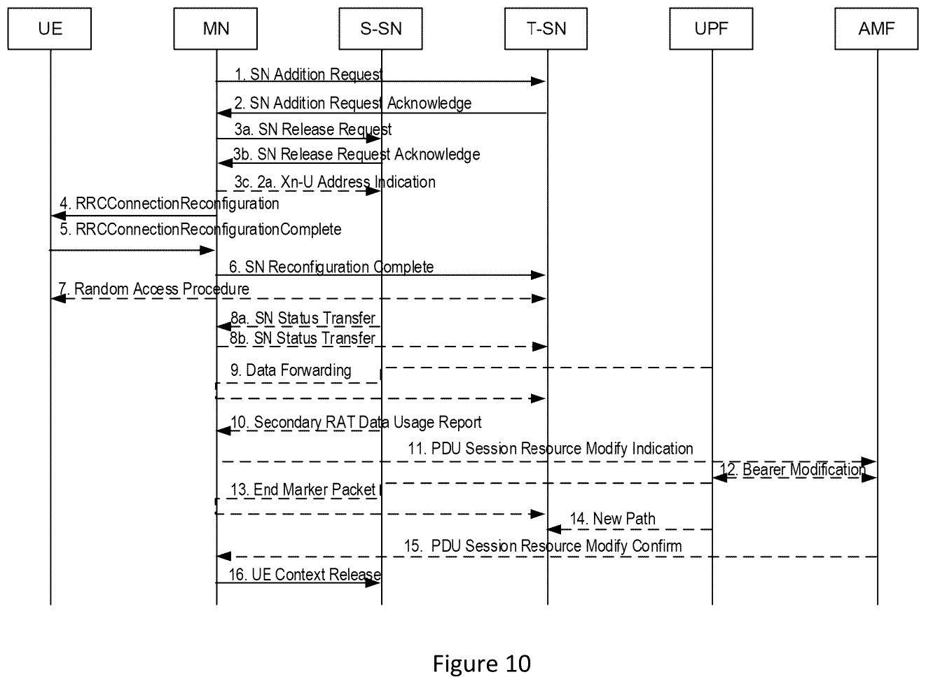

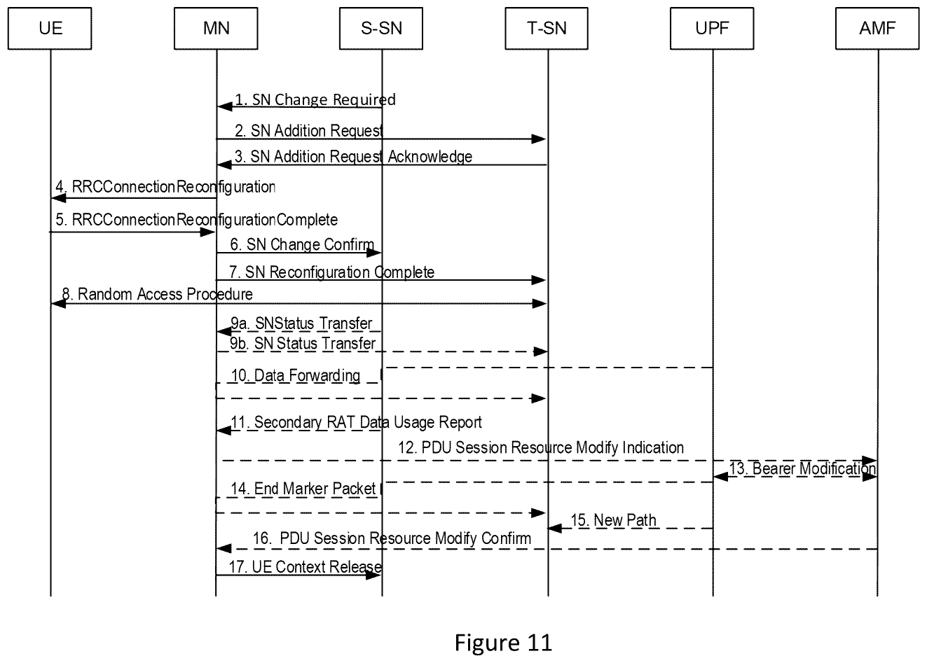

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

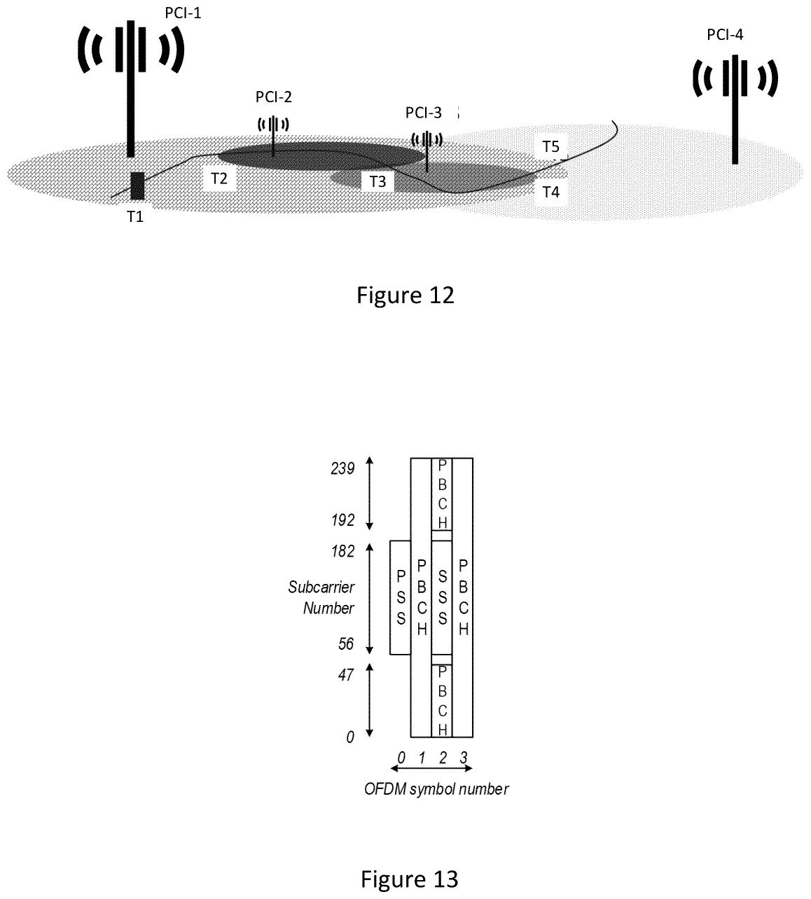

For a UE capable of operating in MR-DC, the MN can add an SCG and/or SN-configuration. In typical deployments, such as shown in FIG. 12, only SRB1 is configured. Hence, in order to properly support SCG mobility (e.g. SN/PSCell change) the UE needs to perform measurements and evaluate measurement events according to an SN/SCG MeasConfig (e.g. A3 event for the serving frequency of PSCell), trigger a measurement report, wraps into an MN message (ULInformationTransferMRDC) and sent to the MN. This requires some processing at the UE to create RRC messages, for example, filter measurements, etc. Upon reception the MN send these measurements to the Source SN (S-SN), so that the S-SN determines to perform PSCell Change e.g. to one of the reported cells.

If the S-SN determines to perform an intra-SN PSCell Change, the S-SN generates an SCG RRCReconfiguration to be provided to the UE, including an SCG reconfiguration with Sync. If the S-SN has a deployment in a CU/DU split, wherein the CU and DU are placed in different locations, the CU requires the DU to generate the CellGroupConfig for the SCG to be included in the SCG RRCReconfiguration. Once that SCG RRCReconfiguration is generated the S-SN sends that to the MN in an SN Modification Required message, so the MN provides to the UE the SCG RRCReconfiguration so that the UE performs the PSCell change, and sends an RRCReconfigurationComplete to the MN (including an SCG RRCReconfigurationComplete). Then, the MN can forward the SCG RRCReconfigurationComplete to the S-SN.

Potential problems to be solved by the embodiments described herein include many SCG failure(s) and high signaling for PSCell change. All the steps for an intra-SN PSCell Change describe take long time and, during the time the UE report measurements to the time it can access the target PSCell, the radio conditions may have changed. That is even more crucial in higher frequencies (e.g. above 6 GHz, like mmWave frequencies in 15 GHs and/or 28 GHz, as in some 5G deployments and/or in terahertz frequencies, envisioned for 6G communication). Hence, due to the MR-DC architecture, that may increase the change of failures during a PSCell change. Moreover, many times a PSCell change needs to be performed, the UE is simply moving between PSCell(s) controlled by the same DU of the S-SN. In other words, despite the fact that the DU controlling the UE remains the same before and after the PSCell change, it would still take quite a long timer until PSCell change happens.

In addition to this, even if the procedure ends up being successful, there is quite a lot of signaling involved in the PSCell Change procedure e.g. between a UE and a MN (measurement reporting, reception of the SCG RRCReconfiguration), between SN and MN, and, if the SN is deployed in a CU/DU split architecture, further signaling between CU and DU, despite the fact that the UE is moved between PCell(s) controlled by the same DU. It could be argued that if SRB3 is configured (no vendor currently implements that) some of these challenges can be overcome. However, if the SN is deployed in a CU/DU split architecture, there is still some signaling between CU and DU. Embodiments herein mitigate one or more of these problems.

The present disclosure uses the terminology in the NR specification as main examples and refer to the Rel-17 feature. However, it is important to mention that this feature may also be applicable in the context of 6G concept development, which can be labeled as Distributed-MIMO (D-MIMO) and/or cell-less mobility.

The term “beam” used in the present disclosure can correspond to a reference signal that is transmitted in a given direction. For example, if may refer to an SS/PBCH Block (SSB) or layer 3 configured CSI-RS in the following sub-section. During a half-frame, different SSBs may be transmitted in different spatial directions (i.e. using different beams, spanning the coverage area of a cell). That corresponds to different SSBs meaning different beams.

The term PCI and/or PCI of an SSB is used. That corresponds to the physical cell identity encoded by a Primary Synchronization Sequence (PSS) and a Secondary Synchronization Sequence (SSS) that are included in an SSB, as shown in FIG. 13, and as defined in [2], wherein the PSS and SSS encode a PCI:

The present disclosure mentions “cells” or a “set of cells” wherein the UE can be configured with to perform L1/L2 centric mobility. These set of cells may be called a set of intra-frequency neighbor cells the UE can perform measurements on and can perform a handover/reconfiguration with sync to, or a set of intra-frequency non-serving cells or simply a set of non-serving cells (in addition to the serving cell). In the particular case of L1/L2 centric mobility for a PSCell(s) the UE can have a serving cell and a set of non-serving cells the UE perform L1 measurements and reporting, and that via MAC CE the UE can change its serving cell.

The term “random access resource selection” can corresponds to a beam selection procedure, wherein the UE selects an SSB and/or a CSI-RS that maps to a PRACH resource for preamble transmission for a given PSCell (or for at least one non-serving cell configured for L1/L2 centric mobility). That can correspond to a procedure to be defined in [1] (5.1.2 Random Access Resource selection) that is to be modified for the method. That may include for example the UE selecting an SSB with SS-RSRP above rsrp-ThresholdSSB amongst the associated SSBs, wherein the associated SSBs according to the method can be associated to more than one PCI (wherein an SS-RSRP is defined in [3]) and/or to more than one cell (e.g. serving cell and/or non-serving cell). That may include for example the UE selecting an SSB with SS-RSRP above rsrp-ThresholdSSB amongst the associated SSBs, wherein the associated SSBs according to the method can be associated to more than one PCI and/or associated to multiple cell(s) associated to set of cell(s), including a serving cell and/or non-serving cell(s).

Upon selecting a beam (e.g. SSB), the UE determines the next available PRACH occasion from the PRACH occasions corresponding to the selected SSB. That can be, for example, the ones permitted by the restrictions given by the ra-ssb-OccasionMasklndex if configured (e.g. the MAC entity shall select a PRACH occasion randomly with equal probability amongst the consecutive PRACH occasions according to clause 8.1 of [3], corresponding to the selected SSB; the MAC entity may take into account the possible occurrence of measurement gaps when determining the next available PRACH occasion corresponding to the selected SSB). Then, the UE perform the Random Access Preamble transmission procedure. The configurations that are used e.g. for PRACH, are the ones associated to the selected SSB and/or PCI of the selected SSB and/or the cell (e.g. serving or non-serving cell) of the selected SSB.

When ASN.1 encoding (for the examples showing signaling), consider [ ] for RRC as a reference for the omitted IEs and field in the messages and/or IEs that are proposed to be extended to implement the systems/methods disclosed herein.

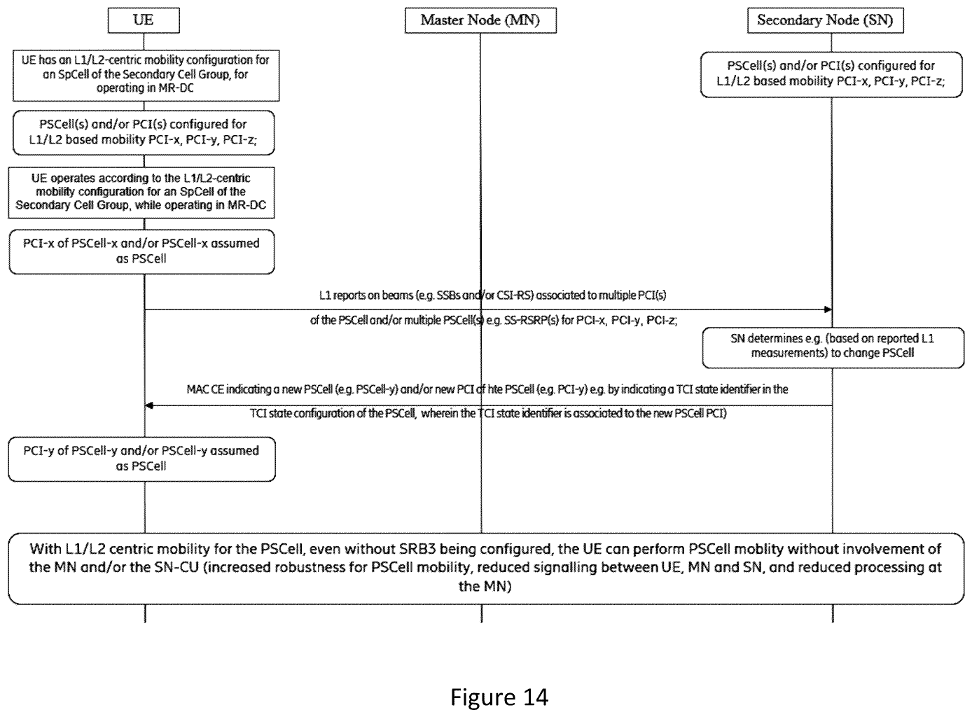

Referring to FIG. 14, a method at a UE according to some embodiments includes receiving a L1/L2-centric mobility configuration for an SpCell of the SCG, for operating in MR-DC; and operating according to the L1/L2-centric mobility configuration for an SpCell of the SCG, while operating in MR-DC; that includes at least the following:
Performing L1 measurements (e.g. SS-RSRP, CSI-RSRP) and/or reporting for cells and/or PCIs in the same frequency of the PSCell that are not the PSCell.
Receiving L1/L2 signaling (e.g. via SCG MAC), such as MAC CE(s), to indicate a PSCell change (e.g. indicate a new PSCell) and/or to indicate a PCI change for the PSCell.

As a note, for Dual Connectivity operation the term “Special Cell” or “SpCell” refers to the PCell of the MCG or the PSCell of the SCG.

Possible Approaches in 3GPP for L1/L2 Centric Mobility for SCG

L1/L2 inter-cell centric mobility or L1 mobility can be understood as a UE in RRC_CONNECTED operating in MR-DC is connected (i.e. being served by) to a serving cell, considered to be the PSCell, also called the SpCell of the SCG, e.g. after the UE performs connection setup, if transitioning from RRC_IDLE to RRC_CONNECTED, or connection resume, transitioning from RRC_INACTIVE to RRC_CONNECTED, wherein the UE has a first PCI associated to that PCell i.e. the PCI in ServingCellConfigCommon for the PSCell the UE is configured with. In the multi-beam scenario, a cell can be associated to multiple SSBs, and during a half-frame, different SSBs may be transmitted in different spatial directions (i.e. using different beams, spanning the coverage area of a cell).

Even though the term “L1/L2 inter-cell centric mobility” has the term “inter-cell”, a fundamental aspect is that the UE's configuration (e.g. the UE's serving cell configuration) can have more than one PCI associated to it, and for that there are at least 2 approaches (or solutions) to create that association:

Approach 1) Intra-cell multi-PCI L1/L2 centric mobility, where same serving cell configuration is associated to more than one PCI (e.g. a TCI state configuration within ServingCellConfig can be associated to a PCI, wherein that can be different from the PCI in ServingCellConfigCommon). For an SN Addition (or PSCell Addition) and/or SN Change (or PSCell Change) and/or, as proposed by the method, the implication is that the SCG configuration the UE receives (e.g. as an nr-scg within an MN RRCReconfiguration) contains the L1/L2 mobility centric configuration (e.g. ServingCellConfig with TCI states associated to PCI(s) that can be different from the PCI in ServingCellConfigCommon, and can be associated to non-serving cells). Another implication is that for an SN Addition (or PSCell Addition) and/or SN Change (or PSCell Change) and/or, as proposed by the method, UE receives random access configuration(s) whose beams (e.g. SSBs and/or CSI-RS) are associated to multiple PCIs (while in prior art the SSBs and CSI-RS of a target cell in handover can only be the SSBs and CSI-RSs associated to the single target cell PCI in ServingCellConfigCommon); or, alternatively, the UE receives random access configuration(s) whose beams (e.g. SSBs and/or CSI-RS) are associated to multiple cells (while in prior art the SSBs and CSI-RS of a target cell in handover can only be the SSBs and CSI-RSs associated to the single cell with a ServingCellConfigCommon).

Approach 2) Inter-cell multi-PCI L1/L2 centric mobility, where the UE has several serving cell configurations with respective PCIs associated but TCI state may refer to other cell PCIs (e.g. other serving cell or, even a non-serving cell the UE can move to with L1/L2 centric mobility). For an SN Addition (or PSCell Addition) and/or SN Change (or PSCell Change) and/or, as proposed by the method, the implication is that the SCG configuration the UE receives contains a configuration prepared by a target node (e.g. a target gNB) that is associated to more than one cell (e.g. TCI state configurations can be associated to multiple cells' PCIs e.g. TCI state Id=1 associated to PCI-x of cell A, TCI state Id=2 associated to PCI-y of cell B, etc.). In other words, for PSCell Addition and/or PSCell Change(s), as proposed by the method, one implication is that the SCG configuration the UE receives (e.g. as an nr-scg within an MN RRCReconfiguration) can contain that L1/L2 mobility centric configuration and/or SCG configuration the UE receives (e.g. as an nr-scg within an MN RRCReconfiguration) can contain a random access configuration whose beams (e.g. SSBs and/or CSI-RS) are associated to multiple cells (while in prior art the SSBs and CSI-RS of a target cell in handover can only be the SSBs and CSI-RSs associated to the single target cell PCI in ServingCellConfigCommon). These multiple cells can be a serving cell and/or non-serving cell(s).

Approach 1) Intra-Cell Multi-PCI L1/L2 Centric Mobility

In the prior art, the UE can receive a MAC CE from the network to indicate the TCI state to be associated to a given PDCCH configuration, while PDSCH TCI state association can be provided via Downlink Control Indication (DCI). Upon reception the UE knows which TCI state (e.g. in which downlink beam PDCCH is being transmitted and should be monitored/received) is associated to a given PDCCH configured to be monitored. In other words, in a system where SS/PBSH Blocks (SSB)s are transmitted in different beams for a given cell with a given PCI, a TCI indication for a given PDCCH configurations triggers the UE to monitor PDCCH in a given beam of that cell associated to its PCI, in this case, a beam/SSB of the serving cell where that TCI state is configured.

However, for the approach 1, concerning the L1/L2 centric mobility, for a given serving cell configuration, there can be a different PCI in a TCI state configuration compared to the PCI in ServingCellConfigCommon, e.g. PCI-1, which is an additional PCI e.g. PCI-2. In that case, the UE receiving the MAC CE needs to determine the PCI associated to the indicated TCI, to determine the SSB (or CSI-RS) associated, hence, determine the downlink beam. If it receives a TCI with PCI indicating PCI-2, for example, the UE needs to monitor PDCCH in a beam/SSB associated to PCI-2. The different PCIs (not the one in ServingCellConfigCommon) can be associated to non-serving cell(s).

(Same cell, change PCI, similar ServingCellConfigCommon) In a first variant of approach 1, the ServingCellConfigCommon before and after the TCI state indication associated to a different PCI than the one in ServingCellConfigCommon (e.g. PCI-2) remains the same, except for the PCI; Hence, the UE could be assumed to be in the same cell after the TCI state indication (e.g. MAC CE) whose TCI state has a different PCI associated to it (not necessarily signaled in the MAC CE, as the TCI state identifier in the MAC CE enables the UE to identify the PCI associated).

(Same cell, change PCI, ServingCellConfigCommon has some cell/PCI-specific configuration(s)) In a second variant of approach 1, the UE is configured with some cell/PCI-specific configuration. In other words, the UE has a ServingCellConfigCommon, valid for the PCI indicated on it, but it contains some further PCI-specific configuration so that upon receiving an indication for a different PCI the UE switches configuration.

In this example, the UE may apply the new ServingCellConfigCommon (for the new PCI/non-serving cell in the MAC CE) on top of the previous ServingCellConfigCommon (e.g. in a delta-signaling manner) or simply replace it. That reduces the amount of signaling for the cell/PCI-specific configurations, in case some of the configurations are the same. That can rely on anperPCIConfigList structure for the PCI(s) associated to L1/L2 centric mobility. An example of that configuration is shown in Table 1 below:

TABLE 1
ServingCellConfigCommon IE

| | |
|---|---|
| ServingCellConfigCommon ::= SEQUENCE {physCellId | PhysCellId |

OPTIONAL, -- Cond HOAndServCellAdd,[...]

| | |
|---|---|
| perPCIConfigList | SEQUENCE (SIZE (1..X)) OF |

ServingCellConfigCommon OPTIONAL, -- Need N
}

Another way to configure the UE is that in serving cell config (e.g. ServingCellConfig) the UE is configured with SSB sets that has other PCI associated to it. These SSB sets would have an index and in TCI state configuration an index of SSB set is referred to together with exact SSB beam index from that SSB set. It is possible these sets will be named differently to reflect “inter PCI candidates”, thus SSB set index is an example of an RRC configuration specific ID given to the PCI (SSB set) to be used in the L1/L2 mobility in UE's current RRC configuration.

According to the method, the UE is configured by a target network node (e.g. a target SN) during a PSCell Addition and/or PSCell Change and/or SN Addition and/or SN Change and/or SN Modification (MN-initiated or SN-initiated) and/or reconfiguration with sync (for an SCG) with L1/L2 centric mobility configuration e.g. configuration associated to multiple PCI(s) e.g. PCI-5, PCI-6, PCI-7 for the target PSCell, i.e., the cell to be the serving cell in the SN frequency. That means that after the PSCell addition/change procedure, the UE would connect to that target PSCell (e.g. via reconfiguration with sync), and it should be possible to perform L1/L2-centric mobility and/or the network could configure the UE to perform L1/L2-centric mobility when moving between e.g. PCI-5, PCI-6, PCI-7, even though according to approach 1 it is said that the UE would still have the same serving cell (i.e. the same PSCell).

Approach 2) In prior art, the UE assumes that the QCL source of a configured TCI state is a Reference Signal (RS) associated to the serving cell's single configured PCI (i.e. the PCI in ServingCellConfigCommon). However, in Approach 2, the UE can be configured with a different PCI in the TCI state configuration where these PCIs are considered to be associated with different cells e.g. to non-serving cells. In that case, the UE can have different serving cell configurations for these PCIs e.g. a set of ServingCellConfigCommon(s) that may be switched upon the change of serving cell via MAC CE.

In other words, the UE is configured with a list of TCI states the UE meaning that it is configured with a list of additional cells (e.g. non-serving cells configured for L1/L2 centric mobility), as the different PCIs are PCIs of different cells (each TCI state has its own PCI, but the same PCI may be used by multiple TCI states). These could be, for example, considered as some kind of serving cells e.g. if these are all in the same frequency (like same ARFCN for their SSB) these could be considered as intra-frequency serving cells, where one is considered to be active at the time (except if some form of multi-TRP transmission is enabled). Or, alternatively, these could be considered as non-serving cells wherein the UE can perform L1/L2 inter-cell centric mobility.

According to the method, the UE is configured by a target network node (e.g. operating as a SN) during a PSCell Addition and/or PSCell Change and/or SN Addition and/or SN Change and/or SN Modification (MN-initiated or SN-initiated) and/or reconfiguration with sync (for an SCG) with L1/L2 centric mobility configuration e.g. configuration associated to multiple cells, each associated to its PCI e.g. cell-5→PCI-5, cell-6→PCI-6, cell-7→PCI-7, wherein multiple cells can form a group or set of cells for L1/2-centric mobility (e.g. possibly including a serving cell and/or multiple non-serving cells). That means that after the PSCell Addition and/or PSCell Change the UE would connect to one of the cells (e.g. serving or non-serving cell), that will be considered the target cell (e.g. via PSCell Addition or PSCell Change, reconfiguration with sync for the SCG), and it should be possible to perform L1/L2-centric mobility and/or the network could configure the UE to perform L1/L2-centric mobility when moving between these cells of the set of cells. That means that if the UE connects to one of these cells (e.g. via reconfiguration with sync for the SCG), like cell-6 of PCI-6, it should be possible to perform L1/L2-centric mobility and/or the network could configure the UE to perform L1/L2-centric mobility when moving between e.g. cell-5→PCI-5, cell-6→PCI-6, cell-7→PCI-7.

In other words, for PSCell Addition and/or PSCell Change, as proposed by the method, one implication is that an SCG reconfiguration (e.g. to be provided within an MN RRCReconfiguration, as nr-scg field in an RRC container) can contain the L1/L2 mobility centric configuration and/or random access configuration(s) whose beams (e.g. SSBs and/or CSI-RS) are associated to multiple cells. These cells can be serving cell(s) and/or non-serving cell(s).

Notice that what is called “changing cell” or “inter-cell” herein does not have the same meaning as changing serving cell as in legacy.

In some embodiments (for SCG Reconfiguration after operating in MR-DC) a method includes receiving the L1/L2-centric mobility configuration for an SpCell of the SCG with a configuration for modifying MR-DC (e.g. an RRCReconfiguration message including a ReconfigurationWithSync IE for the SCG.

The RRCReconfiguration message includes an RRC container (e.g. nr-SCG), e.g., denoted an SCG RRCReconfiguration, so that SCG RRCReconfiguration contains the L1/L2-centric mobility configuration, indicating to the UE is to operate in L1/L2-centric mobility for the current PSCell.

Or in other words, the L1/L2-centric mobility configuration for an SpCell of the SCG is received by the UE after PSCell Addition (or SN Addition from the network's perspective), via an SCG Reconfiguration and/or after a PScell Change (e.g. with SN change).

The method further includes applying the configuration for modifying the MR-DC configuration (and/or changing the PSCell, possibly with SN change) and to add the L1/L2-centric mobility configuration for an SpCell of the SCG, wherein after applying the SCG RRCReconfiguration and after transmitting a Complete message (an RRCReconfigurationComplete message to the MN) the UE starts to perform procedures according to the L1/L2-centric mobility configuration for an SpCell of the SCG. It will be appreciated that as used herein, “modifying” a PSCell refers to changing a PSCell configuration for an existing PSCell, while “changing” a PSCell refers to changing the PSCell of an SCG from one cell to another.

The solution relying on a reconfiguration (SN Modification Required) can have an even reduced latency to configure L1/L2 centric mobility for the PSCell if the UE receives the L1/L2 centric mobility in the same message configuring the SCG i.e. during SN Addition.

In a further embodiment the method includes (SN Addition) receiving the L1/L2-centric mobility configuration for an SpCell of the SCG with a configuration for adding MR-DC (e.g. an RRCReconfiguration message including a ReconfigurationWithSync IE for the SCG).

The RRCReconfiguration message includes an RRC container (e.g. nr-SCG), e.g., denoted an SCG RRCReconfiguration, so that SCG RRCReconfiguration contains the L1/L2-centric mobility configuration, indicating to the UE is to operate in L1/L2-centric mobility for the PSCell that is being added.

In other words, the L1/L2-centric mobility configuration for an SpCell of the SCG is received by the UE during PSCell Addition (or SN Addition from the network's perspective).

The method further includes applying the configuration for adding MR-DC and the L1/L2-centric mobility configuration for an SpCell of the SCG, wherein after performing random access with the SpCell of the SCG and after transmitting a Complete message (an RRCReconfigurationComplete message to the MN) the UE starts to perform procedures according to the L1/L2-centric mobility configuration for an SpCell of the SCG.

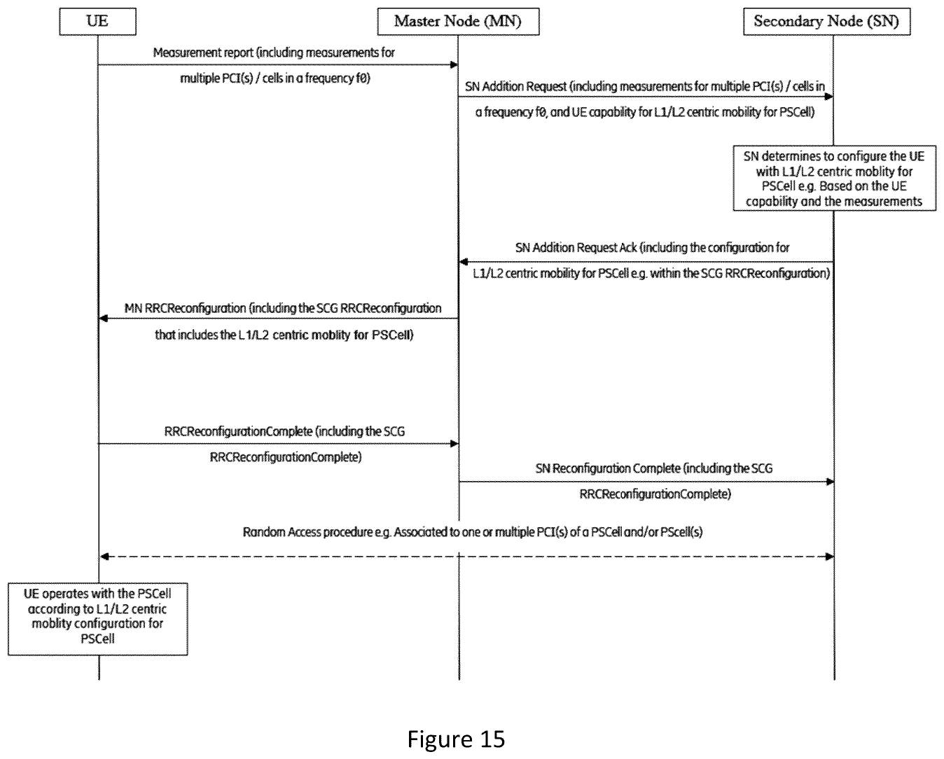

FIG. 15 illustrates operations of a UE, MN and SN according to some embodiments.

Problem Related to PSCell Change with and without SN Change Addressed by Further Embodiments

If L1/L2 centric mobility for a UE in MR-DC, in particular for SCG mobility is available for a capable UE within an SN area covered by a set of PCIs, e.g. PCI-1-PCI-4 for a PSCell and/or PSCell(s), the UE can rely on beam management procedures i.e. L1 measurements/reporting and MAC CE/DCI indications for TCI state change (or any other lower layer signaling like in RLC, MAC or PHY layers in the protocol sack), as proposed in the previous embodiments. However, this area will most likely not be “infinite” e.g. possibly this would be an area within the control of the same distributed unit (DU) and/or common baseband pool.

In practice, there will be deployments like islands wherein the feature is supported i.e. a set of areas, where each area includes a set of PCIs and/or cells (e.g. a serving cell and/or non-serving cells) where the UE can perform L1/L2-centric mobility. Hence, two scenarios that are relevant for the scope of the present disclosure are the following:
First scenario: A UE configured with MR-DC having a PSCell within a first SN area (e.g. S-SN) for the PSCell coverage (e.g. covered by a PSCell and non-serving cells) for which L1/L2-centric mobility is supported (and being configured with L1/L2-centric mobility within this first area for SCG mobility) moves towards a second SN area (neighbor SN) for which L1/L2-centric mobility is also supported e.g. but it is controlled by another DU or Baseband Unit (BBU).
Second scenario: A UE configured with MR-DC within a first area (e.g. S-SN) for which L1/L2-centric mobility for SCG is not supported (i.e. not configured with L1/L2-centric mobility within this first area) moves towards a second area for which L1/L2-centric mobility for SCG is supported.

In both scenarios the point is that the UE moves towards an area for which L1/L2-centric mobility for SCG is supported (neighbor area). The term “moves” indicate mobility but fundamentally it means the UE can detect cells/beams of that second area, and possibly trigger measurement report (e.g. based on A3 events).

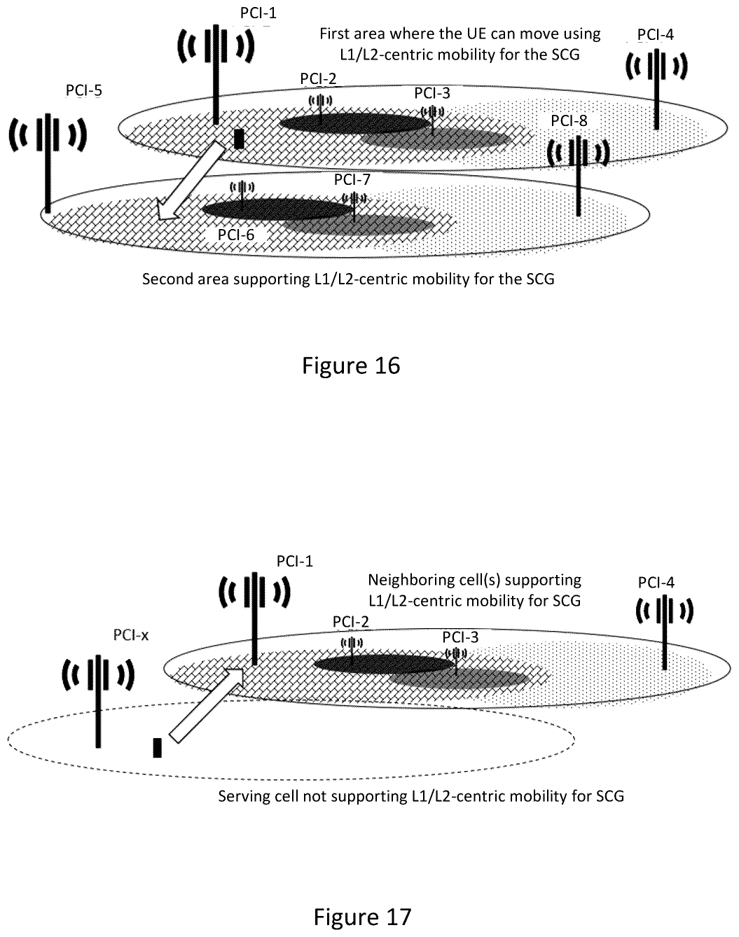

FIG. 16 shows an illustration for the first scenario. FIG. 17 shows an illustration for the second scenario.

The solution relying on a reconfiguration (SN Modification Required) can have an even reduced latency to configure L1/L2 centric mobility for the PSCell during a PSCell Change e.g. with SN change, if the UE receives the L1/L2 centric mobility in the same message triggering the PSCell Change i.e. the SCG RRCReconfiguration including a reconfiguration with sync for a PSCell change.

In an embodiment, the method includes (SN Change or Modification) receiving a second L1/L2-centric mobility configuration for an SpCell of the SCG with a configuration for modifying an existing MR-DC configuration (e.g. an RRCReconfiguration message including a ReconfigurationWithSync IE for the SCG, wherein the PSCell is to be changed, as in a PSCell Change, possibly with SN change; or without including a ReconfigurationWithSync IE for the SCG, if it is an SCG modification without changing the PSCell).

The RRCReconfiguration message above includes an RRC container (e.g. nr-SCG), e.g., denoted an SCG RRCReconfiguration, so that SCG RRCReconfiguration contains the L1/L2-centric mobility configuration, indicating to the UE is to operate in L1/L2-centric mobility for the PSCell according to the newly provided configuration.

Or in other words, the L1/L2-centric mobility configuration for an SpCell of the SCG is received by the UE during PSCell Change or Modification (or SN Change or Modification from the network's perspective).

The method further includes applying the configuration for changing or modifying MR-DC and the second L1/L2-centric mobility configuration for an SpCell of the SCG, wherein after performing random access with the SpCell of the SCG and after transmitting a Complete message (an RRCReconfigurationComplete message to the MN) the UE starts to perform procedures according to the L1/L2-centric mobility configuration for an SpCell of the SCG.

In one option the second L1/L2-centric mobility configuration for an SpCell of the SCG replaces the L1/L2-centric mobility configuration for an SpCell of the SCG the UE has stored.

In another option the second L1/L2-centric mobility configuration for an SpCell of the SCG is applied on top of the L1/L2-centric mobility configuration for an SpCell of the SCG the UE has stored, in a delta signaling manner, according to Need Codes defined in RRC (e.g. for fields with Need Code M, the absence of a field in the second L1/L2-centric mobility configuration for an SpCell of the SCG leads the UE to keep using the stored field.

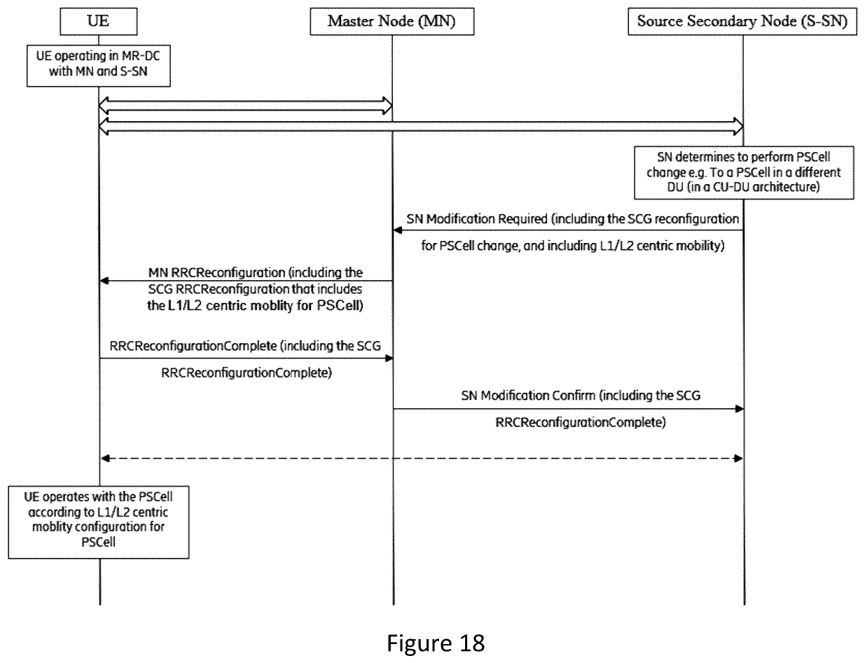

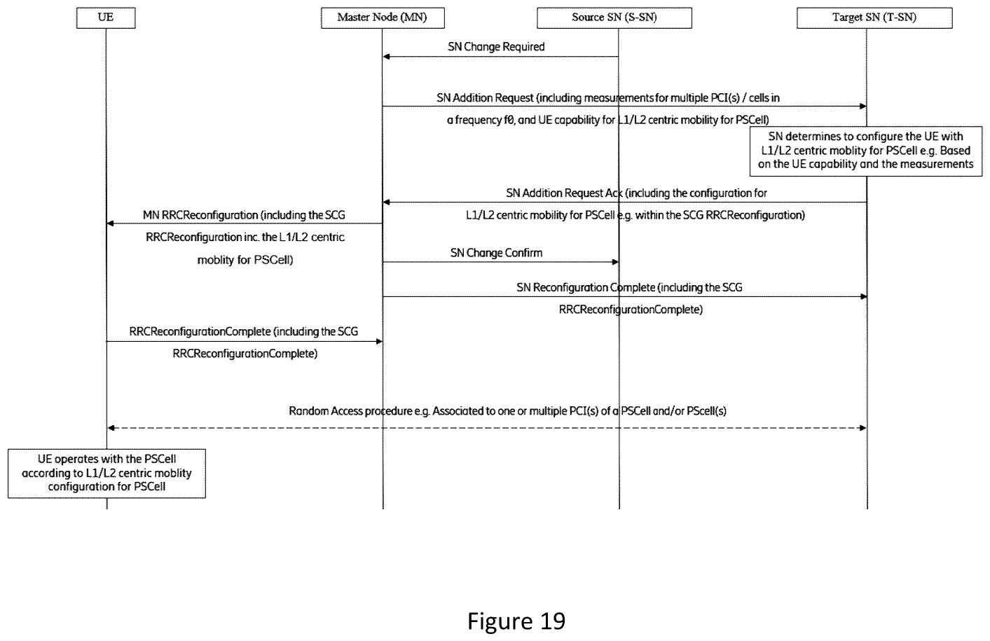

FIGS. 18 and 19 illustrate operations according to some embodiments.

Enhancements for Random Access Procedure During PSCell Change and/or PSCell Addition with L1/L2-Centric Mobility Configuration

TA method may include the UE receiving a contention free random access (CFRA) configuration associated to a plurality of beams (e.g. SSBs, CSI-RSs, or a combination of SSBs and CSI-RSs), wherein each beam may be associated to a different PCI or a different PCI of a PSCell and/or a different PSCell and/or a non-serving cell e.g. beam-1 associated to PCI-5 or PCI-5 of a PSCell-5 and/or a PSCell-5, beam-2 associated to PCI-6 or PCI-6 of a PSCell-6 and/or a PSCell-6, beam-3 associated to PCI-7 or PCI-7 of a PSCell-7 and/or a PSCell-7, and the L1/L2-centric mobility configuration for an SpCell of the SCG and at least one of the following:
A configuration for adding MR-DC (e.g. an RRCReconfiguration message including a ReconfigurationWithSync IE for the SCG).
A configuration for changing or modifying MR-DC (e.g. an RRCReconfiguration message including a ReconfigurationWithSync IE for the SCG).

If solution 1 is adopted, this is one of the PCI's of the target cell. If approach 2 is adopted, this is one of the cells that can be accessed during the PSCell Addition and/or PSCell Change.

In one example, there are a set of common random-access parameters considered for the different PCIs (and/or for the different cells, including serving and non-serving cells), but the SSBs and/or CSI-RS resources can be defined in the configuration per PCI (and/or per cell). Thus, while in prior art a resource index (SSB index/identifier, CSI-RS index/identifier) was provided so the PCI for that resource index was considered to be the PCI in ServingCellConfigCommon within ReconfigurationWithSync (field physCellId of IE PhysCellId) for the SCG, according to this example of the method, a PCI (a field physCellId witin RACH-COnfigDedicated) can be provided for each SSB and/or CSI-RS to be selected upon random access. One possible advantage is that most of the CFRA configuration remains the same, except that the UE can select a beam from a set of beams associated to different PCIs (and/or cells).

In another example, the UE receives multiple instances of CFRA configuration(s) (e.g. listRach-ConfigDedicatedPerPCI and/or per cell) each instance associated to a PCI and/or a cell (e.g. Rach-ConfigDedicatedPerPCI). Each instance of CFRA is provided per PCI and/or cell, within the ReconfigurationWithSync IE for the SCG. In this example, the UE considers the PCI and/or cell for each SSB and/or CSI-RS during beam selection (i.e. random access resource selection) the PCI within the instance of the CFRA configuration wherein the resources are configured (e.g. SSB index and/or CSI-RS index).

The method further includes performing a random access procedure to a PSCell, upon a PSCell Addition and/or upon PSCell Change based on the CFRA configuration, the procedure including the UE performing a random access resource selection i.e. selecting PRACH resources for transmission of a preamble based on one of the configured beams (e.g. based on the configured SSBs, CSI-RSs, or a combination thereof) e.g. the UE selects a beam in the CFRA configuration, and determines the resource associated to the selected beam to transmit a preamble. The UE transmits the preamble, receives a random access response (RAR), and transmits the RRC Reconfiguration Complete.

In a further embodiment the method includes the UE receiving a contention based random access (CBRA) configuration associated to a plurality of beams (e.g. SSBs, CSI-RSs, or a combination thereof), wherein each beam may be associated to a different PCI or different PCI of a PSCell and/or a different PSCell and/or a non-serving cell, and the L1/L2-centric mobility configuration for an SpCell of the SCG and at least one of the following:
A configuration for adding MR-DC (e.g. an RRCReconfiguration message including a ReconfigurationWithSync IE for the SCG).
A configuration for changing or modifying MR-DC (e.g. an RRCReconfiguration message including a ReconfigurationWithSync IE for the SCG).

The method further includes performing a random access procedure based on the CBRA configuration to a PSCell, upon a PSCell Addition and/or PSCell Change, based on the CFRA configuration, the procedure including the UE performing a random access resource selection i.e. selecting PRACH (resources for transmission of a preamble based on one of the configured beams e.g. the UE selects a beam in the CFRA configuration, and determines the resource associated to the selected beam to transmit a preamble. The UE transmits the preamble, receives a RAR, and transmits the RRC Reconfiguration Complete.

In one embodiment, the method allows a L1/L2-centric mobility configuration(s) for the SCG as a delta signaling e.g. to be defined as Need Code M, wherein the absence of a configuration in a given message means the UE shall keep using the stored configuration(s). For example, in case the UE is moving from an area with PCI-1, PCI-2 to an area with an overlapping PCIs, e.g., PCI-2, and PCI-5, the signaling may add PCI-5 and remove PCI-1, in an SCG configuration, while PCI-2 (and associated configuration(s)) may remain intact at the UE. That can be useful e.g. if the UE has a limited number of PCIs and/or cells to support L1/L2 centric mobility so that as the UE moves at some point network updates the list with RRC signaling for that (even if the UE is still moving between cells of the same DU and/or BBU). That may rely on a AddMod list structure for adding TCI states associated to different PCI(s) and/or ServingCellConfigCommon IE(s), for per-PCI and/or per-cell configuration(s).

In one embodiment the UE receives in the SCG reconfiguration a CBRA configuration associated to a plurality of beams, wherein each beam may be associated to a different PCI e.g. beam-1 associated to PCI-5, beam-2 associated to PCI-6, beam-3 associated to PCI-7.

In conventional approaches, CBRA configuration is provided within ServingCellConfigCommon, within the Reconfiguration with Sync IE for the SCG, wherein the beams that may be selected during random access, to be mapped to random access resources for preamble transmissions, are associated to the PCI configured in ServingCellConfigCommon. However, according to the method, CBRA configuration(s) wherein beams to be selected and mapped to random access resources for preamble transmissions are received in at least one of the following:
Multiple instances of ServingCellConfigCommon configurations (list-spCellConfigCommon of IE SEQUENCE (SIZE(1 . . . K1)) OF ServingCellConfigCommon), one per PCI the UE can access in the PSCell Addition or the PSCell Change e.g. within ReconfigurationWithSync. In one option the UE supporting this feature may ignore the field spCellConfigCommon and only use a list-spCellConfigCommon; Another option is that the UE considers the list-spCellConfigCommon as the list of additional configurations for the additional PCIs, but still considers spCellConfigCommon as one of these configurations. In yet another option, the UE considers the list-spCellConfigCommon as the list of additional configurations for the additional PCIs, while still considers spCellConfigCommon as the high priority or main of these configurations (wherein there can be further UE actions taking that into account such as first try to access the beams associated to the high priority PCI/ServingCellConfigCommon configuration.
Within ServingCellConfigCommon, there may be multiple instances of the UplinkConfigCommon IE, each associated to a PCI and/or cell (which would lead to RACH configurations, one per PCI; Beams within are associated to that PCI).
Within ServingCellConfigCommon, there may be multiple instances of RACH configurations, one per PCI; Beams within are associated to that PCI).
Within ServingCellConfigCommon, and within the RACH configuration, there can be configurations of beams per PCI.
Within ServingCellConfigCommon, and within the RACH configuration, for each beam there can be a configured PCI (that is not necessarily the same as the PCI within ServingCellConfigCommon).
Multiple instances of ReconfigurationWithSync IEs ServingCellConfigCommon configurations (list-spCellConfigCommon of IE SEQUENCE (SIZE(1 . . . K1)) OF ServingCellConfigCommon), one per PCI and/or cell the UE can access in the handover e.g. within ReconfigurationWithSync; in that case, there would be an instance of timer T304 value for each PCI and/or cell that could be accessed; hence, upon selecting an SSB the UE determines the PCI and/or cell associated and applies the associated configuration e.g. starts the timer T304 with a value within that configuration.

In one embodiment, the UE performs a random access procedure based on the CFRA configuration as described above. When the UE transmits the RRC Reconfiguration Complete, it is done via the MN (including within an SN RRC Reconfiguration Complete). There could be different rules and/or configuration(s) determining how the UE performs CFRA when resources associated to multiple PCIs and/or multiple cells are configured, for example for PSCell Addition or PSCell Change, at least one of the following:
Prioritize the CFRA for the main PCI and/or main PSCell, wherein that can be indicated in the RACH dedicated configuration or that is the PCI and/or cell indicated in servingCellConfigCommon;
Select any SSB and/or CSI-RS (according to other conditions e.g. above an RSRP threshold) associated to any of the configured PCIs and/or configured cells.
Select an SSB and/or CSI-RS (according to other conditions e.g. above an RSRP threshold) according to an order of priority for the different PCIs and/or different cells. For example, if SCG configuration has configured PCI-5, PCI-6 and PCI-7, and beams associated for random access for each of these PCIs and/or cells, and each of them have different priorities, the UE should start by trying to select the beams associated with the PCI and/or cell with highest priority.

In one embodiment the UE performs a random access procedure based on the CBRA configuration: the UE performs a random access resource selection (i.e. selecting resources for transmission of a preamble) based on one of the configured beams e.g. the UE selects a beam in the CBRA configuration, and determines the resource associated to the selected beam to transmit a preamble. The UE receives a RAR, and transmits the RRC Reconfiguration Complete via the MN (including an SN RRCReconfigurationComplete).

In another embodiment, the UE is configured with both CFRA configuration and CBRA configurations, wherein at least one of the configuration(s) contain beam(s) to be selected (for random access resource selection/mapping) associated to different PCIs and/or cells (e.g. PSCells, serving cell and/or non-serving cells), and performs random access resource selection according to at least one of the rules:
The UE tries to select a beam above the threshold amongst the beams associated to a high priority PCI and/or cell within CFRA configuration; If not possible (e.g. no suitable beam, no beam above a configurable threshold, wherein configuration may also be per PCI and/or per cell), the UE selects a beam associated to a high priority PCI and/or cell within CBRA configuration; If not possible (e.g. no suitable beam, no beam above a configurable threshold, wherein configuration may also be per PCI and/or per cell), the UE selects a beam associated to a lower priority PCI and/or cell with a CFRA configuration; If not possible (e.g. no suitable beam, no beam above a configurable threshold, wherein configuration may also be per PCI and/or per cell), the UE selects a beam associated to a lower priority PCI within a CBRA configuration.
The UE tries to select a beam above the threshold amongst the beams associated to a high priority PCI and/or cell within the CFRA; If not possible, the UE selects a beam associated to a lower priority PCI and/or cell having an associated CFRA configuration; If not possible, the UE selects a beam associated to a high priority PCI and/or cell within the CBRA; If not possible, UE selects a beam associated to a lower priority PCI and/or cell within the CBRA;
the UE tries to select any beam above the threshold amongst the beams within CFRA configuration, associated to any of the configured PCIs and/or cell; If not possible, the UE selects any beam within CBRA, associated to any of the PCIs and/or cell.

The method includes the configuration of a threshold, as described above. In legacy there is one threshold for beam selection based on SSB (e.g. valid for both CBRA and CFRA) and one threshold for beam selection for CSI-RS (valid for CFRA). According to the method, different granularity can be defined for configuring the threshold for beam selection during random access, also per RS type (i.e. per SSB and CSI-RS), and per PCI and/or per cell that can be accessed/selected for random access, at least as follows:
Threshold per SSB per PCI and/or cell; while currently one SSB RSRP threshold is defined (as there is a single PCI configured), according to the method there can be one SSB RSRP threshold per PCI and/or cell, as there can be different PCIs and/or cells associated to the multiple SSBs; In one option, that is valid for CBRA and CFRA.
Threshold per CSI-RS per PCI and/or per cell; while currently one CSI-RS RSRP threshold is defined (as there is a single PCI configured), according to the method there can be one CSI-RS RSRP threshold per PCI and/or cell, as there can be different PCIs and/or cells associated to the multiple CSI-RS resources; In one option, that is valid for CFRA.
Threshold per PCI and/or cell for both CBRA and CFRA.
Threshold per PCI and/or cell for CBRA and Threshold per PCI and/or cell for CFRA.

In another embodiment, after beam selection the UE selects a random access resource associated to that selected beam. That selection can be done according to one of the following at least:
Each set of RACH resources (e.g. for preamble transmission) is associated to a configured PCI and/or cell; Hence, if the UE selects a beam associated to a PCI and/or cell, the UE determines the resources to transmit the preamble associated to the PCI and/or cell associated to the selected beam e.g. PCI included in the selected SSB.
A common set of RACH resources (e.g. for preamble transmission) is associated to all configured PCIs; Hence, if the UE selects a beam associated to a PCI and/or cell, the UE determines the resources to transmit the preamble associated to the configured PCIs associated to the selected beam e.g. PCI and/or cell included in the selected SSB.
In another variant, the UE is not receiving predetermined RACH resources, or is receiving these in the serving cell config common only for the initial or main SSB/PCI. Depending if this is the case or not, the UE may initially choose whether to perform CFRA for the given resources or contention based random access to a beam selected by the UE. There may be specific rules how to select the beam. For example, to select the best beam, or select a beam that is above a threshold.

Below are shown further examples of L1/L2 centric mobility configuration to be included in the SCG reconfiguration according to the method, for a UE to perform L1/L2 centric mobility procedures for a PSCell and/or for the SCG.

In one example, the L1/L2 centric mobility configuration for the SCG (in particular for the PSCell) includes a list of TCI states configuration(s), wherein a TCI state configuration can be associated to an indication of a PCI, in Table 2 below.

TABLE 2
TCI-State information element

-- ASN1START
-- TAG-TCI-STATE-START

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

...
}

| QCL-Info ::= | SEQUENCE { | |
|---|---|---|
| cell | ServCellIndex | OPTIONAL, -- Need R |
| bwp-Id | BWP-Id | OPTIONAL, -- Cond CSI-RS- |

Indicated

| | |
|---|---|
| referenceSignal | CHOICE { |
| csi-rs | NZP-CSI-RS-ResourceId, |
| ssb | SSB-Index |

},

| | |
|---|---|
| | pci |
| | PhysCellId OPTIONAL, -- Need R |
| qcl-Type | ENUMERATED {typeA, typeB, typeC, typeD}, |

```
    ...
}
  ...
}
-- TAG-TCI-STATE-STOP
-- ASN1STOP
PhysCellId information element
-- ASN1START
-- TAG-PHYSCELLID-START
```

| | |
|---|---|
| PhysCellId ::= | INTEGER (0..1007) |

-- TAG-PHYSCELLID-STOP
-- ASN1STOP

Common Configuration (Per PCI)

In another example, the L1/L2 centric mobility configuration for the SCG includes cell-/PCI-specific configuration(s) for at least one cell/PCI being configured for L1/L2-centric mobility. For example, in the IE ServingCellConfigCommon within the ReconfigurationWithSync IE for the SCG the UE receives, there is a list of additional ServingCellConfigCommon IEs, one per possible PCI the UE is configured with, as shown in Table 3 below.

TABLE 3
ReconfigurationWithSync IE and ServingCellConfigCommon IE

| ReconfigurationWithSync ::= | SEQUENCE { | |
|---|---|---|
| spCellConfigCommon | ServingCellConfigCommon | OPTIONAL, |

-- Need M
[...]
}
[...]

| | |
|---|---|
| ServingCellConfigCommon ::= | SEQUENCE { |

| | |
|---|---|
| physCellId PhysCellId | OPTIONAL, -- Cond |

HOAndServCellAdd,
[...]

| | |
|---|---|
| perPCIConfigList | SEQUENCE (SIZE (1..X)) OF |

ServingCellConfigCommon OPTIONAL, -- Need N
}

When the UE receives that in the SCG reconfiguration it means that the UE applies the configurations within the main ServingCellConfigCommon except the ones in perPCIConfigList (these configurations are stored and only applied upon reception of a MAC CE). Then, after the handover, upon reception of a MAC CE indicating a change to PCI-x, the UE applies the ServingCellConfigCommon within perPCIConfigList associated to PCI-x.

Another option for implementing this example is shown below, wherein these per PCI-configuration(s) are within ReconfigurationWithSync, but provided as a list of ServingCellConfigCommon IEs, one per PCI, as shown in Table 4.

TABLE 4
ReconfiguratioWithSync IE

| ReconfigurationWithSync ::= | SEQUENCE { | |
|---|---|---|
| spCellConfigCommon | ServingCellConfigCommon | OPTIONAL, |

| -- Need M | |
|---|---|
| [...] | |
| perPCIConfigList | SEQUENCE (SIZE (1..X)) OF |

ServingCellConfigCommon OPTIONAL, -- Need N
}

When the UE receives that in the SCG configuration it means that the UE applies the configurations within the spCellConfigCommon, but it does not apply perPCIConfigList (these configurations are stored and only applied upon reception of a MAC CE). Then, after the SCG reconfiguration (e.g. PSCell Addition or PSCell Change), upon reception of a MAC CE indicating a change to PCI-x, the UE applies the ServingCellConfigCommon within perPCIConfigList associated to PCI-x. That helps the UE to avoid the acquisition of at least some system information upon L1/L2 centric mobility indicating a change of PCI.

Common Configuration (Per Cell)

In another example, the L1/L2 centric mobility configuration includes cell-specific configuration(s) for at least one cell being configured for L1/L2-centric mobility (e.g. a serving cell and non-serving cells). For example, in the IE ServingCellConfigCommon within the ReconfigurationWithSync IE the UE receives, there is a list of additional ServingCellConfigCommon IEs, one per possible cell the UE is configured with, as shown in Table 5 below.

TABLE 5
ReconfigurationWithSync IE and ServingCellConfigCommon IE

| ReconfigurationWithSync ::= | SEQUENCE { | |
|---|---|---|
| spCellConfigCommon | ServingCellConfigCommon | OPTIONAL, |

-- Need M
[...]
}
[...]

| ServingCellConfigCommon ::= | SEQUENCE { | |
|---|---|---|
| physCellId | PhysCellId | OPTIONAL, -- Cond |

HOAndServCellAdd,
[...]

| | |
|---|---|
| perCellConfigList | SEQUENCE (SIZE (1..X)) OF |

ServingCellConfigCommon OPTIONAL, -- Need N
]

When the UE receives that in the SCG reconfiguration it means that the UE applies the configurations within the main ServingCellConfigCommon except the ones in perCellConfigList (these configurations are stored and only applied upon reception of a MAC CE). Then, after the handover, upon reception of a MAC CE indicating a change to cell-x (e.g. for PCI-x), the UE applies the ServingCellConfigCommon within perCellConfigList associated to cell-x (of PCI-x).

Another option for implementing this example is shown below, wherein these per cell-configuration(s) are within ReconfigurationWithSync, but provided as a list of ServingCellConfigCommon IEs, one per cell, as shown in Table 6 below.

TABLE 6
ReconfigurationWithSync IE

| ReconfigurationWithSync ::= | SEQUENCE { | |
|---|---|---|
| spCellConfigCommon | ServingCellConfigCommon | OPTIONAL, |

| -- Need M | |
|---|---|
| [...] | |
| perCellConfigList | SEQUENCE (SIZE (1..X)) OF |

ServingCellConfigCommon OPTIONAL, -- Need N
}

When the UE receives that in the SCG reconfiguration it means that the UE applies the configurations within the spCellConfigCommon, but it does not apply perCellConfigList (these configurations are stored and only applied upon reception of a MAC CE). Then, after the PScell Addition or PSCell Change, upon reception of a MAC CE indicating a change to cell-x, the UE applies the ServingCellConfigCommon within perCellConfigList associated to cell-x. That helps the UE to avoid the acquisition of at least some system information upon L1/L2 centric mobility indicating a change of cell to cell-x.

Configuration of Contention Based Random Access (Per PCI or Per Cell)

In the previous example, the UE receives multiple ServingCellConfigCommon IEs in the SCG reconfiguration. Each of these ServingCellConfigCommon IEs contains configuration(s) for CBRA procedure. During random access the UE can select a beam e.g. an SSB, and determine to which cell that beam is associated e.g. by determining the PCI of the selected SSB. And, depending on selected SSB/Cell, the UE determines which ServingCellConfigCommon to apply to continue with the contention based random access procedure and the handover procedure. The handling for CBRA configurations can be different as they can be outside ServingCellConfigCommon and within the ReconfigurationWithSync for the SCG (or at least parts of the CFRA configuration(s) e.g. the list of candidate beams, the dedicated preambles, etc.).

Dedicated Configurations

In another example, a L1/L2 centric mobility configuration includes dedicated configuration(s). For example, they can be provided within cell group configuration, as a configuration of a set of cells, wherein each cell in the set has at least one field within the IE SpCellConfig. The spCellConfig of IE SpCellConfig is to be applied upon reception of the RRCReconfiguration, so UE acts accordingly upon the handover. However, one of the other configurations e.g. an element of setOfCellsConfig, is to be applied upon reception of a MAC CE changing the cell with L1/L2 centric mobility. That allows the network to change the dedicate SpCellConfig using the L1/L2 centric mobility mechanism. These configurations are shown in Table 7 below.

TABLE 7
CellGroupConfig IE

| | |
|---|---|
| Table _- CellGroupConfig IECellGroupConfig ::= | SEQUENCE { |

[...]

| | | |
|---|---|---|
| spCellConfig | SpCellConfig | OPTIONAL, -- Need M |

| | |
|---|---|
| sCellToAddModList | SEQUENCE (SIZE (1..maxNrofSCells)) OF SCellConfig |

OPTIONAL, -- Need N

| | |
|---|---|
| setOfCellsConfig | SEQUENCE (SIZE (1..K)) OF SpCellConfig OPTIONAL, |

-- Need N
[...]
}

One option related to the example is that upon reception of that configuration in an SCG reconfiguration, the UE deletes the previous list (configuration for the set of cells before the SCG reconfiguration, in case the was also configured with L1/L2 centric mobility before the SCG reconfiguration).

Even further examples of L1/L2 centric configuration(s), to be included in the SCG reconfiguration according to the method, are provided in the following:

Table 8 shows an example where both SSB/PCI and related CSI-RSs are configured directly in ServingCellConfig.

TABLE 8
ServingCellConfig

| | |
|---|---|
| ServingCellConfig ::= | SEQUENCE { |

[...]
]],
[[

| | |
|---|---|
| l1MObility-r17 | SetupRelease { L1Mobility-r17 } |

]]
}
L1Mobility ::= SEQUENCE {

| physicalCellId-r17 | PhysCellId, | |
|---|---|---|
| ssb-IndexNcell-r17 | SSB-Index | OPTIONAL, -- |

Need S

| | | |
|---|---|---|
| ssb-Configuration-r17 | SSB-Configuration-r17 | OPTIONAL -- |

Need S

| | |
|---|---|
| subcarrierSpacing | SubcarrierSpacing, |
| csi-RS-CellList | SEQUENCE (SIZE (1..maxNrofCSI-RS)) OF CSI-RS-L1MObility, |

}

| | |
|---|---|
| CSI-RS-L1MObility::= | SEQUENCE { |
| cellId | PhysCellId, |
| csi-rs-MeasurementBW | SEQUENCE { |
| nrofPRBs | ENUMERATED { size24, size48, size96, size192, size264}, |
| startPRB | INTEGER(0..2169) |

},

| | | |
|---|---|---|
| density | ENUMERATED {d1,d3} | OPTIONAL, |

-- Need R

| | |
|---|---|
| csi-rs-ResourceL1List | SEQUENCE (SIZE (1..maxNrofCSI-RS)) OF CSI-RS-ResourceL1 |

}

| | |
|---|---|
| CSI-RS-ResourceL1 ::= | SEQUENCE { |
| csi-RS-Index | CSI-RS-Index, |
| slotConfig | CHOICE { |
| ms4 | INTEGER (0..31), |
| ms5 | INTEGER (0..39), |
| ms10 | INTEGER (0..79), |
| ms20 | INTEGER (0..159), |
| ms40 | INTEGER (0..319) |

},

| | |
|---|---|
| associatedSSB | SEQUENCE { |
| ssb-Index | SSB-Index, |
| isQuasiColocated | BOOLEAN |

| | |
|---|---|
| } | OPTIONAL, -- Need R |

| | |
|---|---|
| frequencyDomainAllocation | CHOICE { |
| row1 | BIT STRING (SIZE (4)), |
| row2 | BIT STRING (SIZE (12)) |

},

| | |
|---|---|
| firstOFDMSymbolInTimeDomain | INTEGER (0..13), |
| sequenceGenerationConfig | INTEGER (0..1023), |

}

In a variant, these can be given in the measObjectNR which is included in the servingcellConfig as shown in Table 9 below.

TABLE 9
measObjectNR IE

| | |
|---|---|
| MeasObjectNR ::= | SEQUENCE { |

[...]

| | | |
|---|---|---|
| rmtc-Config-r16 | SetupRelease {RMTC-Config-r16} | OPTIONAL, |

-- Need M

| | | |
|---|---|---|
| t312-r16 | SetupRelease { T312-r16 } | OPTIONAL -- |

Need M
]],
[[

| | |
|---|---|
| l1MObility-r17 | SetupRelease { L1Mobility-r17 } |

]]
}
L1Mobility ::= SEQUENCE {

| physicalCellId-r17 | PhysCellId, | |
|---|---|---|
| ssb-IndexNcell-r17 | SSB-Index | OPTIONAL, -- |

Need S

| | | |
|---|---|---|
| ssb-Configuration-r17 | SSB-Configuration-r17 | OPTIONAL -- |

Need S

| | |
|---|---|
| subcarrierSpacing | SubcarrierSpacing, |
| csi-RS-CellList | SEQUENCE (SIZE (1..maxNrofCSI-RS)) OF CSI-RS-L1MObility, |

}

| | |
|---|---|
| CSI-RS-L1MObility::= | SEQUENCE { |
| cellId | PhysCellId, |
| csi-rs-MeasurementBW | SEQUENCE { |
| nrofPRBs | ENUMERATED { size24, size48, size96, size192, size264}, |
| startPRB | INTEGER(0..2169) |

},

| | | |
|---|---|---|
| density | ENUMERATED {d1,d3} | OPTIONAL, |

-- Need R

| | |
|---|---|
| csi-rs-ResourceL1List | SEQUENCE (SIZE (1..maxNrofCSI-RS)) OF CSI-RS-ResourceL1 |

}

| | |
|---|---|
| CSI-RS-ResourceL1 ::= | SEQUENCE { |
| csi-RS-Index | CSI-RS-Index, |
| slotConfig | CHOICE { |
| ms4 | INTEGER (0..31), |
| ms5 | INTEGER (0..39), |
| ms10 | INTEGER (0..79), |
| ms20 | INTEGER (0..159), |
| ms40 | INTEGER (0..319) |

},

| | |
|---|---|
| associatedSSB | SEQUENCE { |
| ssb-Index | SSB-Index, |
| isQuasiColocated | BOOLEAN |

| | |
|---|---|
| } | OPTIONAL, -- Need R |

| | |
|---|---|
| frequencyDomainAllocation | CHOICE { |
| row1 | BIT STRING (SIZE (4)), |
| row2 | BIT STRING (SIZE (12)) |

},

| | |
|---|---|
| firstOFDMSymbolInTimeDomain | INTEGER (0..13), |
| sequenceGenerationConfig | INTEGER (0..1023), |

}

Example of giving initial TCI state for PDCCH (PDCCH-Config includes the ControlResourceSet) and for PUCCH is shown in Table 10 below.

TABLE 10
ControlResourceSet IE and PUCCH-Config IE

| | |
|---|---|
| ControlResourceSet ::= | SEQUENCE { |

[...]

| | | |
|---|---|---|
| controlResourceSetId-v1610 | ControlResourceSetId-v1610 | OPTIONAL - |

- Need S
]],
[[

| | |
|---|---|
| initialTCI-State TCI-StateId | OPTIONAL --Need R |

]]
}

| | |
|---|---|
| PUCCH-Config ::= | SEQUENCE { |

[...]
schedulingRequestResourceToAddModList-v1610 SEQUENCE (SIZE (1..maxNrofSR-
Resources)) OF SchedulingRequestResourceConfig-v1610

OPTIONAL -- Need N

]],
[[
initial-SpatialRelation PUCCH-SpatialRelationInfold OPTIONAL --Need R
]]
}
[...]

The methods described above are applicable for the following network nodes (MN, source SN (s-SN), and target SN (t-SN)) in the following cases:
SN Addition: MN and SN
SN Modification: MN and SN
SN Change: MN, S-SN and T-SN

A method at a first network node, operating as a SN (e.g. gNodeB as an SN) during an SN Addition or an SN Change (or a message) according to some embodiments includes receiving an SN Addition Request from a second network node (operating as a MN for a UE configured with MR-DC) including measurements, wherein the measurement results are associated to multiple cells (e.g. serving and non-serving cells) and/or multiple PCIs associated to the target network node.

The SN Addition Request can be an XnAP message including an RRC container, wherein the RRC container includes measurement information (e.g. measurement results like RSRP, RSRQ, SINR per cell and/or per beam) associated to multiple cells/PCIs.

These measurement results can be measurements per cell e.g. based on SSBs and/or CSI-RSs. These measurement results can be measurement information per beam e.g. measurement information per SSB index and/or CSI-RS index, for the cells/PCIs included in the HO Request; For example, that may be an SS-RSRP for SSB index 5 of PCI-x, and that may be an SS-RSRQ for SSB index 7 of PCI-z.

The SN Addition Request can include a UE capability information associated to the support for L1/L2 centric mobility for that UE for the SCG; That capability information may be at least one of the following:
Whether the UE supports or not L1/L2 centric mobility for the SCG; and/or
If the UE supports L1/L2 centric mobility SCG, up to how many cells the UE can be configured with for L1/L2 centric mobility (e.g. maximum number of cells, among serving and non-serving cells); and/or
If the UE supports L1/L2 centric mobility for the SCG, up to how many PCIs for the target cell and/or cells the UE can be configured with for L1/L2 centric mobility for the SCG (e.g. maximum number of PCIs in ServingCellConfig).

The method further includes determining a set of cells and/or a set of PCI(s), for which the UE can be configured with L1/L2 centric mobility based on at least one of the following:
the measurements associated to multiple cells and/or PCI(s) e.g. cell measurement results and/or beam measurement results; and/or
the UE capability information associated to the support for L1/L2 centric mobility for the SCG.

For example, the target node can determine to configure for L1/L2 centric mobility in the target node the cells for which the best quality was reported by the UE and/or the cells with higher number of beams whose measurements are above a certain threshold, etc.

The method further includes determining at least one RACH configuration based on the measurement information received in the SN Addition Request.

A RACH configuration may be a CFRAconfiguration associated to a plurality of beams (e.g. SSBs, CSI-RSs, or a combination of SSBs and CSI-RSs), wherein each beam may be associated to a different PCI and/or cell. That can be determined e.g. based on the measurements per beam for the multiple cells/PCIs. The configuration can include preamble, RAR parameters, a list of candidate beams that include beams associated to multiple PCI(s) and/or cells (e.g. candidate SSBs for PCI-x and PCI-y, and/or candidate SSBs for cell-x and cell-y).

A RACH configuration may be a CBRA configuration associated to a plurality of beams, wherein each beam may be associated to a different PCI and/or cell. That can be determined e.g. based on the measurements per beam for the multiple cells/PCIs. The configuration can include preamble, RAR parameters, a list of allowed candidate beams that include beams associated to multiple PCI(s) and/or cells (e.g. candidate SSBs for PCI-x and PCI-y, and/or candidate SSBs for cell-x and cell-y) and/or a list of allowed cells and/or PCI(s) the UE is allowed to select beams (e.g. SSBs) for random access resource selection.

The method further includes generating an SCG reconfiguration (e.g. an SN RRCReconfiguration) to be included in an RRC container that is sent to the MN.

The SCG reconfiguration may include a L1/L2 centric mobility configuration for the SCG.

The method further includes transmitting an Acknowledge message to the second network node operating as source network node (e.g. a source gNodeB), including in an RRC container the HO command e.g. the RRCReconfiguration including the reconfiguration with sync e.g. an SN Addition Acknowledge message.

The method further includes Receiving from the UE a random-access preamble in a random access resource (e.g. a PRACH resource in time and frequency domain).

This may determine an associated beam (e.g. associated SSB) the UE has selected for the random access resource selection and/or may determine an associated cell and/or PCI of the selected beam (e.g. associated SSB) e.g. the PCI encoded by the PSS/SSS of the SSB the UE has selected.

The method further includes receiving from the MN an RRC Reconfiguration Complete (e.g. an RRCReconfigurationComplete message), wherein the UE has transmitted to the MN and the MN has forwarded to the SN.

The method further includes starting to operate according to the L1/L2 centric mobility configuration for the SCG e.g. receive L1 measurements from the UE for beams (e.g. SSBs) associated to beams of non-serving cell(s) and/or beams associated to multiple PCIs configured for that serving cell.

A method at a second network node, operating as a MN (e.g. gNB) during an SN Addition or an SN Change according to some embodiments includes transmitting an SN Addition Request to a first network node (operating as a SN during an SN Addition or SN Change) including measurements, wherein the measurement results are associated to multiple cells and/or multiple PCIs associated to the target network node, and wherein these measurement were reported by the UE (according to a measurement configuration configured by the first network node).

The method further includes receiving an SN Addition Request Acknowledge message from the first network node operating as SN (e.g. gNB), including in an RRC container the SCG reconfiguration e.g. the RRCReconfiguration including the reconfiguration with sync for the SCG.

The RRCReconfiguration further includes the reconfiguration with sync for the SCG in an MN RRCReconfiguration (e.g. in nr-scg container) and transmit that to the UE.

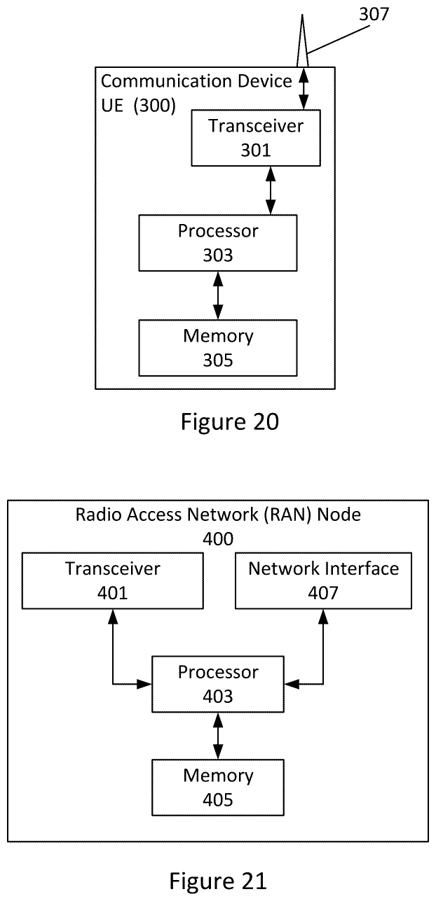

FIG. 20 is a block diagram illustrating elements of a communication device UE 300 (also referred to as a mobile terminal/communication terminal/device, a wireless device/communication device/terminal/communication terminal, a UE, a UE node/terminal/device, etc.) configured to provide wireless communication according to embodiments of inventive concepts. As shown, UE 300 may include an antenna 307, and transceiver circuitry 301 including a transmitter and a receiver configured to provide uplink and downlink radio communications with a base station(s) of a radio access network. UE 300 may also include processing circuitry 303 coupled to the transceiver circuitry, and memory circuitry 305 coupled to the processing circuitry. The memory circuitry 305 may include computer readable program code that when executed by the processing circuitry 303 causes the processing circuitry to perform operations according to embodiments disclosed herein. According to other embodiments, processing circuitry 303 may be defined to include memory so that separate memory circuitry is not required. UE 300 may also include an interface (such as a user interface) coupled with processing circuitry 303, and/or UE 300 may be incorporated in a vehicle.

As discussed herein, operations of UE 300 may be performed by processing circuitry 303 and/or transceiver circuitry 301. For example, processing circuitry 303 may control transceiver circuitry 301 to transmit communications through transceiver circuitry 301 over a radio interface to a RAN node (also referred to as a base station) and/or to receive communications through transceiver circuitry 301 from a RAN node over a radio interface. According to some embodiments, UE 300 and/or an element(s)/function(s) thereof may be embodied as a virtual node/nodes and/or a virtual machine/machines.

FIG. 21 is a block diagram illustrating elements of a RAN node 400 (also referred to as a network node, base station, eNodeB/eNB, gNodeB/gNB, etc.) of a Radio Access Network (RAN) configured to provide cellular communication according to embodiments of inventive concepts. As shown, the RAN node may include transceiver circuitry 401 including a transmitter and a receiver configured to provide uplink and downlink radio communications with mobile terminals. The RAN node may include network interface circuitry 407 configured to provide communications with other nodes (e.g., with other base stations) of the RAN and/or core network CN. The network node may also include processing circuitry 403 coupled to the transceiver circuitry, and memory circuitry 405 coupled to the processing circuitry. The memory circuitry 405 may include computer readable program code that when executed by the processing circuitry 403 causes the processing circuitry to perform operations according to embodiments disclosed herein. According to other embodiments, processing circuitry 403 may be defined to include memory so that a separate memory circuitry is not required.

As discussed herein, operations of the RAN node may be performed by processing circuitry 403, network interface 407, and/or transceiver 401. For example, processing circuitry 403 may control transceiver 401 to transmit downlink communications through transceiver 401 over a radio interface to one or more UEs and/or to receive uplink communications through transceiver 401 from one or more UEs over a radio interface. Similarly, processing circuitry 403 may control network interface 407 to transmit communications through network interface 407 to one or more other network nodes and/or to receive communications through network interface from one or more other network nodes. According to some embodiments, RAN node 400 and/or an element(s)/function(s) thereof may be embodied as a virtual node/nodes and/or a virtual machine/machines.

According to some other embodiments, a network node may be implemented as a core network CN node without a transceiver. In such embodiments, transmission to UE 300 may be initiated by the network node so that transmission to the UE is provided through a network node including a transceiver (e.g., through a base station or RAN node). According to embodiments where the network node is a RAN node including a transceiver, initiating transmission may include transmitting through the transceiver.

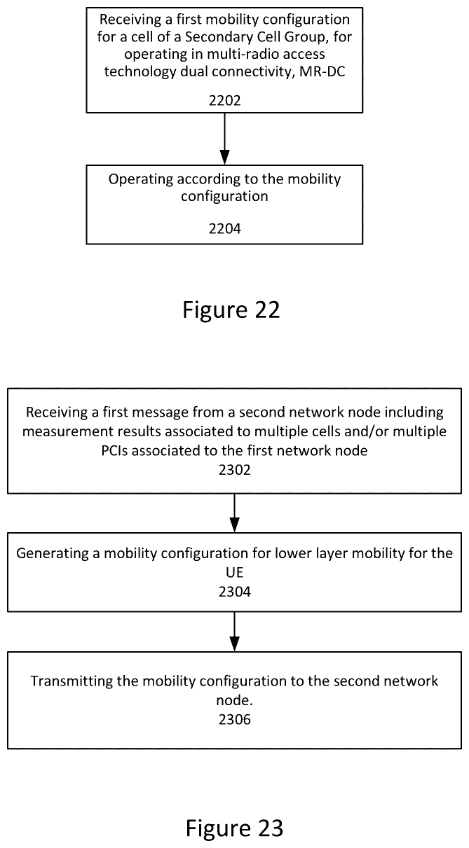

Operations of a UE 300 (implemented using the structure of FIG. 20) will now be discussed with reference to the flow chart of FIG. 22 according to some embodiments of inventive concepts. For example, modules may be stored in memory 305 of FIG. 20, and these modules may provide instructions so that when the instructions of a module are executed by respective UE processing circuitry 303, processing circuitry 303 performs respective operations of the flow chart.

Referring to FIG. 22, a method in operating a UE includes receiving (block 2202) a first mobility configuration for lower layer mobility associated to multiple physical cell identities, PCIs, for a cell, of a Secondary Cell Group, SCG, for operating in multi-radio access technology dual connectivity, MR-DC. The lower layer mobility is used to trigger a change of PCI upon reception of a lower layer signaling by the UE. The method further includes operating (block 2204) according to the mobility configuration for the cell of the SCG while operating in MR-DC.

The cell may be a special cell, Spcell, of the SCG. The special cell may include a primary SCG cell, PSCell, of the SCG.

The multiple PCIs may correspond to cells operating in a same serving frequency.

Operating according to the mobility configuration may include at least one of performing L1 measurements or reporting for cells operating in a same frequency as the cell, and receiving the lower layer signaling. The L1 measurements may include synchronization signal reference signal received power, RSRP, and/or channel state information RSRP measurements.

The lower layer signaling may include a MAC CE that indicates a change of a primary SCG cell, PSCell, of the SCG and/or that indicates a PCI change for the PSCell.

In some embodiments, the method further includes receiving the mobility configuration for the cell of the SCG with a configuration for modifying or adding MR-DC for the UE, and applying the configuration for modifying or adding MR-DC for the UE. The configuration for modifying or adding MR-DC may be provided in a reconfiguration message for the SCG. The reconfiguration message may include synchronization information.

In some embodiments, the method may further include receiving a second mobility configuration for the cell of the SCG. The second mobility configuration may include a mobility configuration for lower layer mobility associated to multiple PCIs for the cell, along with a higher layer configuration for changing a primary SCG cell, PSCell, of the SCG. The method may further include applying the higher layer configuration for changing the PSCell and the second mobility configuration. After performing random access based on the higher layer configuration, the UE starts to perform procedures according to the second mobility configuration.

In some embodiments, the method may further include receiving a CFRA configuration associated to a plurality of beams, wherein each beam may be associated to a different PCI, wherein the CFRA configuration may be received with the first mobility configuration, and performing a random access procedure on the CFRA configuration.

The CFRA configuration may include at least one of a configuration for adding MR-DC and a configuration for changing or modifying MR-DC.

In some embodiments, the method may further include receiving a CBRA configuration associated to a plurality of beams, wherein the CBRA configuration may be received with the first mobility configuration, and performing a random access procedure based on the CBRA configuration.

The CBRA configuration may include at least one of a configuration for adding MR-DC, and a configuration for changing or modifying MR-DC.

Referring to FIGS. 20 and 22, a user equipment, UE, (300) according to some embodiments includes processing circuitry (303), and memory (305) coupled with the processing circuitry, wherein the memory includes instructions that when executed by the processing circuitry causes the UE to perform operations of the method of FIG. 22.

A user equipment, UE, (300) according to some embodiments is adapted to perform operations of the method of FIG. 22.

A computer program product according to some embodiments includes a non-transitory storage medium including program code to be executed by processing circuitry (303) of a user equipment, UE, (300), whereby execution of the program code causes the UE (300) to perform operations of the method of FIG. 22.

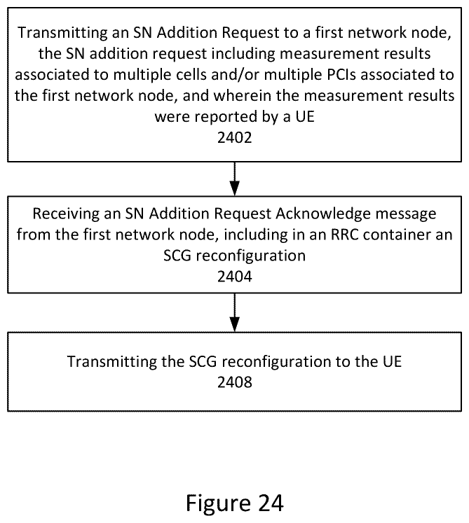

Operations of a RAN node 400 (implemented using the structure of FIG. 21) will now be discussed with reference to the flow charts of FIGS. 23 and 24 according to some embodiments of inventive concepts. For example, modules may be stored in memory 405 of FIG. 21, and these modules may provide instructions so that when the instructions of a module are executed by respective RAN node processing circuitry 403, processing circuitry 403 performs respective operations of the flow chart.

Referring to FIG. 23, a method of operating a first network node includes receiving (block 2302), from a second network node, measurement results for a UE served by the second network node. The measurement results are associated to multiple cells or PCIs associated to the first network node. The method further includes generating (block 2304) a mobility configuration for lower layer mobility of the UE associated to the multiple PCIs. The lower layer mobility is used to trigger a change of PCI of a cell in a SCG of the UE upon reception of a lower layer signaling by the UE. The method further includes transmitting (block 2306) the mobility configuration to the first node for transmission to the UE.

The measurement results can be received in a SN Addition request, for example. The mobility configuration for lower layer mobility can be a L1/L2 mobility.

Generating the mobility configuration may include determining a set of cells and/or a set of PCI(s), for which the UE can be configured with lower layer mobility.

Generating the mobility configuration may include generating an SCG reconfiguration to be included in an RRC container that may be sent to a master node, MN serving the UE.

Transmitting the mobility configuration may include transmitting a message to the second network node, the message including a handover, HO, command including the mobility configuration.

The method may further include receiving, from the UE, a random-access preamble in a random access resource, and operating according to the first mobility configuration for the SCG. Operating according to the first mobility configuration for the SCG may include receiving layer one, L1, measurements from the UE for beams of non-serving cell(s) and/or beams associated to multiple PCIs configured for a serving cell.

The measurement results may include measurement information per cell and/or measurement information on a per beam basis.

The method may further include determining a random access channel, RACH, configuration based on the measurement results. The RACH configuration may include a contention free random access, CFRA, configuration associated to a plurality of beams, wherein each beam is associated to a different PCI or cell, or a contention based random access, CBRA, configuration associated to the plurality of beams.

Referring to FIGS. 21 and 23, a radio access network, RAN, node (400) according to some embodiments includes processing circuitry (403), and memory (405) coupled with the processing circuitry, wherein the memory includes instructions that when executed by the processing circuitry causes the RAN node to perform operations of the method of FIG. 23.

A RAN, node (400) according to some embodiments is adapted to perform operations of the method of FIG. 23.

A computer program product according to some embodiments includes a non-transitory storage medium including program code to be executed by processing circuitry (403) of a RAN node (400), whereby execution of the program code causes the RAN node (400) to perform operations of the method of FIG. 23.

Referring to FIG. 24, a method of operating a second network node according to some embodiments includes transmitting (block 2402) a first message (e.g. SN addition request) to a first network node. The first message includes measurement results associated to multiple cells or multiple PCIs associated to the first network node. The measurement results were reported to the second network node by a UE served by the second network node. The method further includes receiving (block 2404) a second message from the first network node, the second message including a SCG reconfiguration, and transmitting (block 2406) the SCG reconfiguration to the UE.

Referring to FIGS. 21 and 24, a RAN node (400) according to some embodiments includes processing circuitry (403), and memory (405) coupled with the processing circuitry, wherein the memory includes instructions that when executed by the processing circuitry causes the RAN node to perform operations of the method of FIG. 24. A computer program product according to some embodiments includes a non-transitory storage medium including program code to be executed by processing circuitry (403) of a radio access network, RAN, node (400), whereby execution of the program code causes the RAN node (400) to perform the method of FIG. 24.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “include”, “including”, “includes”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

### REFERENCES

[1] 3GPP TS 38.321 v16.2.1
[2] 3GPP TS 38.211 v16.3.0
[3] 3GPP TS 38.213 v16.3.0
[4] 3GPP TS 38.133 v16.5.0
[5] 3GPP TS37.340 v16.3.0
[6] 3GPP TS 36.300 v16.3.0

1. A method of operating user equipment, UE, comprising:
receiving a first mobility configuration for lower layer mobility associated to multiple physical cell identities, PCIs, for a cell, of a Secondary Cell Group, SCG, for operating in multi-radio access technology dual connectivity, MR-DC, wherein the lower layer mobility is used to trigger a change of PCI upon reception of a lower layer signaling by the UE; and
operating according to the mobility configuration for the cell of the SCG while operating in MR-DC.

2. The method of claim 1, wherein the cell comprises a special cell, Spcell, of the SCG.

3. The method of claim 2, wherein the special cell comprises a primary SCG cell, PSCell, of the SCG.

4. The method of claim 1, wherein the multiple PCIs correspond to cells operating in a same serving frequency.

5. The method of claim 1, wherein operating according to the mobility configuration comprises at least one of:
performing layer one, L1, measurements or reporting for cells operating in a same frequency as the cell; and
receiving the lower layer signaling.

6. The method of claim 5, wherein the L1 measurements comprise synchronization signal reference signal received power, RSRP, and/or channel state information RSRP measurements.

7. The method of claim 1, wherein the lower layer signaling comprises a medium access control, MAC, control element that indicates a change of a primary SCG cell, PSCell, of the SCG and/or that indicates a PCI change for the PSCell.

8. The method of claim 1, wherein the method further comprises:
receiving the mobility configuration for the cell of the SCG with a configuration for modifying or adding MR-DC for the UE; and
applying the configuration for modifying or adding MR-DC for the UE.

9. The method of claim 8, wherein the configuration for modifying or adding MR-DC is provided in a reconfiguration message for the SCG.

10. The method of claim 9, wherein the reconfiguration message comprises synchronization information.

11. The method of claim 1, further comprising:
receiving a second mobility configuration for the cell of the SCG, wherein the second mobility configuration comprises a mobility configuration for lower layer mobility associated to multiple PCIs for the cell, along with a higher layer configuration for changing a primary SCG cell, PSCell, of the SCG; and
applying the higher layer configuration for changing the PSCell and the second mobility configuration, wherein after performing random access based on the higher layer configuration, the UE starts to perform procedures according to the second mobility configuration.

12. The method of claim 1, further comprising:
receiving a contention free random access, CFRA, configuration associated to a plurality of beams, wherein each beam is associated to a different PCI, wherein the CFRA configuration is received with the first mobility configuration; and
performing a random access procedure based on the CFRA configuration.

13. The method of claim 12, wherein the CFRA configuration comprises at least one of:
a configuration for adding MR-DC and a configuration for changing or modifying MR-DC; and
a configuration for changing or modifying MR-DC.

14. The method of claim 1, further comprising:
receiving a contention based random access, CBRA, configuration associated to a plurality of beams, wherein the CBRA configuration is received with the first mobility configuration; and
performing a random access procedure based on the CBRA configuration.

15. The method of claim 14, wherein the CBRA configuration comprises at least one of:
a configuration for adding MR-DC; and
a configuration for changing or modifying MR-DC.

16.-19. (canceled)

20. A method of operating a first network node, comprising:
receiving, from a second network node, measurement results for a user equipment, UE, served by the second network node, the measurement results associated to multiple cells or physical cell identities, PCIs, associated to the first network node;
generating a mobility configuration for lower layer mobility of the UE associated to the multiple PCIs, wherein the lower layer mobility is used to trigger a change of PCI of a cell in a secondary cell group, SCG, of the UE upon reception of a lower layer signaling by the UE; and
transmitting the mobility configuration to the first node for transmission to the UE.

21. The method of claim 20, wherein generating the mobility configuration comprises determining a set of cells and/or a set of PCI(s), for which the UE can be configured with lower layer mobility.

22. The method of claim 20, wherein the message comprises a secondary node, SN, addition request.

23. The method of claim 20, wherein generating the mobility configuration comprises generating an SCG reconfiguration to be included in an RRC container that is sent to a master node, MN serving the UE.

24. The method of claim 20, wherein transmitting the mobility configuration comprises transmitting a message to the second network node, the message including a handover, HO, command comprising the mobility configuration.

25.-35. (canceled)
